(19) United States
(12) Patent Application Publication
(10) Pub. No.: US 2021/0350823 A1
(43) Pub. Date: Nov. 11, 2021

(54) SYSTEMS AND METHODS FOR PROCESSING AUDIO AND VIDEO USING A VOICE PRINT

(71) Applicant: OrCam Technologies Ltd., Jerusalem (IL)

(72) Inventors: Yonatan Wexler, Jerusalem (IL); Amnon Shashua, Mevaseret Zion (IL)

(73) Assignee: Orcam Technologies Ltd., Jerusalem (IL)

(21) Appl. No.: 17/315,780

(22) Filed: May 10, 2021

Related U.S. Application Data
(60) Provisional application No. 63/022,600, filed on May 11, 2020.

(51) Int. Cl. G10L 25/84; H04R 5/04; H04R 3/00; G10L 15/07

(52) U.S. Cl. CPC G10L 25/84; H04R 5/04; G10L 2025/783; G10L 15/07; H04R 3/005

(57) ABSTRACT

A wearable device for processing audio signals may include a microphone configured to capture sounds from an environment of a user and at least one processor. The processor may be programmed to receive first audio signals captured by the microphone during a first time period during which the user is in a location, and obtain an audio segment from the first audio signals. The audio segment may include a portion of the first audio signals in which an individual is speaking. The processor may also be programmed to generate a voice print of the individual using at least the audio segment, and receive second audio signals representative of additional sounds captured by the microphone. The additional sounds may include sounds made by the individual. The second audio signals may be at least one of audio signals captured by the microphone within a predetermined time period after the first time period, or audio signals captured by the microphone while the user is in the location. The at least one processor may also be programmed to process the second audio signals using the generated voice print.

### CROSS REFERENCE TO RELATED APPLICATION

This application claims priority to and the benefit of U.S. Provisional Application No. 63/022,600, filed May 11, 2020, which is hereby incorporated by reference in its entirety.

### BACKGROUND

### Technical Field

This disclosure generally relates to devices and methods for capturing and processing images and audio from an environment of a user, and using information derived from captured images and audio.

### Background Information

Today, technological advancements make it possible for wearable devices to automatically capture images and audio, and store information that is associated with the captured images and audio. Certain devices have been used to digitally record aspects and personal experiences of one's life in an exercise typically called “lifelogging.” Some individuals log their life so they can retrieve moments from past activities, for example, social events, trips, etc. Lifelogging may also have significant benefits in other fields (e.g., business, fitness and healthcare, and social research). Lifelogging devices, while useful for tracking daily activities, may be improved with capability to enhance one's interaction in his environment with feedback and other advanced functionality based on the analysis of captured image and audio data.

Even though users can capture images and audio with their smartphones and some smartphone applications can process the captured information, smartphones may not be the best platform for serving as lifelogging apparatuses in view of their size and design. Lifelogging apparatuses should be small and light, so they can be easily worn. Moreover, with improvements in image capture devices, including wearable apparatuses, additional functionality may be provided to assist users in navigating in and around an environment, identifying persons and objects they encounter, and providing feedback to the users about their surroundings and activities. Therefore, there is a need for apparatuses and methods for automatically capturing and processing images and audio to provide useful information to users of the apparatuses, and for systems and methods to process and leverage information gathered by the apparatuses.

### SUMMARY

Embodiments consistent with the present disclosure provide devices and methods for automatically capturing and processing images and audio from an environment of a user, and systems and methods for processing information related to images and audio captured from the environment of the user.

In an embodiment, a wearable device for processing audio signals is disclosed. The wearable device may include a microphone configured to capture sounds from an environment of a user of the wearable device and at least one processor. The at least one processor may be programmed to receive first audio signals representative of sounds captured by the microphone during a first time period during which the user is in a location and obtain an audio segment from the first audio signals. The audio segment may include a portion of the first audio signals in which an individual is speaking, generate a voice print of the individual using at least the audio segment, and receive second audio signals representative of additional sounds captured by the microphone. The additional sounds may include sounds made by the individual and the second audio signals may be at least one of (a) audio signals captured by the microphone within a predetermined time period after the first time period, or (b) audio signals captured by the microphone while the user is in the location. The at least one processor may also be programmed to process the second audio signals using the generated voice print.

In another embodiment, a method of processing audio signals is disclosed. The method may include receiving first audio signals from a microphone of a wearable device. The first audio signals may be representative of sounds captured by the microphone during a first time period during which a user of the wearable device is in a location. The method may also include obtaining an audio segment from the first audio signals. The audio segment may include a portion of the first audio signals in which an individual is speaking. The method may also include generating a voice print of the individual using at least the audio segment, receiving second audio signals representative of additional sounds captured by the microphone. The additional sounds may include sounds made by the individual and the second audio signals may be at least one of (a) audio signals captured by the microphone within a predetermined time period after the first time period, or (b) audio signals captured by the microphone while the user is in the location. The method may further include processing the second audio signals using the generated voice print.

Consistent with other disclosed embodiments, non-transitory computer readable storage media may store program instructions, which are executed by at least one processor and perform any of the methods described herein.

The foregoing general description and the following detailed description are exemplary and explanatory only and are not restrictive of the claims.

### BRIEF DESCRIPTION OF THE DRAWINGS

The accompanying drawings, which are incorporated in and constitute a part of this disclosure, illustrate various disclosed embodiments. In the drawings:

FIG. 1A is a schematic illustration of an example of a user wearing a wearable apparatus according to a disclosed embodiment.

FIG. 1B is a schematic illustration of an example of the user wearing a wearable apparatus according to a disclosed embodiment.

FIG. 1C is a schematic illustration of an example of the user wearing a wearable apparatus according to a disclosed embodiment.

FIG. 1D is a schematic illustration of an example of the user wearing a wearable apparatus according to a disclosed embodiment.

FIG. 2 is a schematic illustration of an example system consistent with the disclosed embodiments.

FIG. 3A is a schematic illustration of an example of the wearable apparatus shown in FIG. 1A.

FIG. 3B is an exploded view of the example of the wearable apparatus shown in FIG. 3A.

FIG. 4A-4K are schematic illustrations of an example of the wearable apparatus shown in FIG. 1B from various viewpoints.

FIG. 5A is a block diagram illustrating an example of the components of a wearable apparatus according to a first embodiment.

FIG. 5B is a block diagram illustrating an example of the components of a wearable apparatus according to a second embodiment.

FIG. 5C is a block diagram illustrating an example of the components of a wearable apparatus according to a third embodiment.

FIG. 6 illustrates an exemplary embodiment of a memory containing software modules consistent with the present disclosure.

FIG. 7 is a schematic illustration of an embodiment of a wearable apparatus including an orientable image capture unit.

FIG. 8 is a schematic illustration of an example of a user wearing an apparatus for a camera-based hearing aid device according to a disclosed embodiment.

FIG. 9 is a schematic illustration of an embodiment of an apparatus securable to an article of clothing consistent with the present disclosure.

FIG. 10 is a schematic illustration showing an exemplary environment for use of a camera-based hearing aid consistent with the present disclosure.

FIG. 11 is a flowchart showing an exemplary process for selectively amplifying sounds emanating from a detected look direction of a user consistent with disclosed embodiments.

FIG. 12 is a schematic illustration showing an exemplary environment for use of a hearing aid with voice and/or image recognition consistent with the present disclosure.

FIG. 13 illustrates an exemplary embodiment of an apparatus comprising facial and voice recognition components consistent with the present disclosure.

FIG. 14 is a flowchart showing an exemplary process for selectively amplifying audio signals associated with a voice of a recognized individual consistent with disclosed embodiments.

FIG. 15 is a flowchart showing an exemplary process for selectively transmitting audio signals associated with a voice of a recognized user consistent with disclosed embodiments.

FIG. 16 is a schematic illustration of a user of wearable apparatus interacting with multiple individuals at a location consistent with disclosed embodiments.

FIGS. 17 and 18 are flowcharts showing exemplary processes for processing audio signals consistent with disclosed embodiments.

FIG. 19 is an illustration of an exemplary database used in association with a wearable apparatus of the current disclosure in some embodiments.

FIG. 20 is flowchart showing another exemplary process for processing audio signals consistent with a disclosed embodiment.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions or modifications may be made to the components illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope is defined by the appended claims.

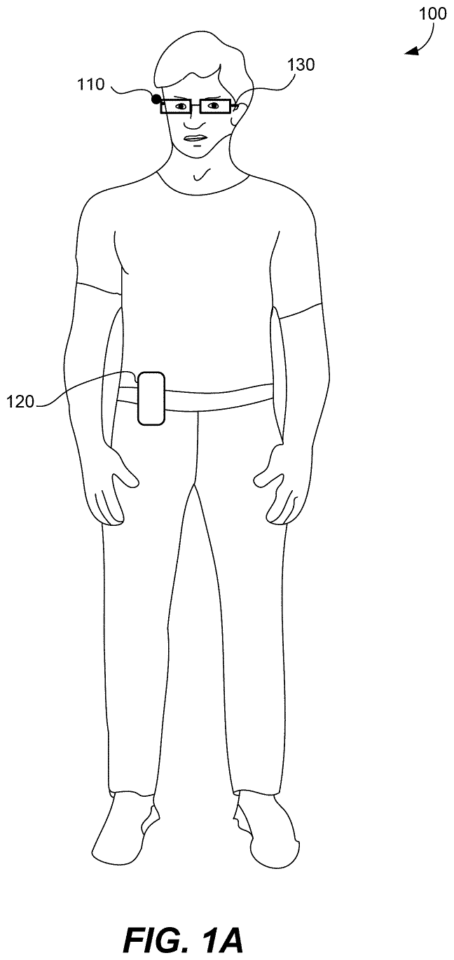

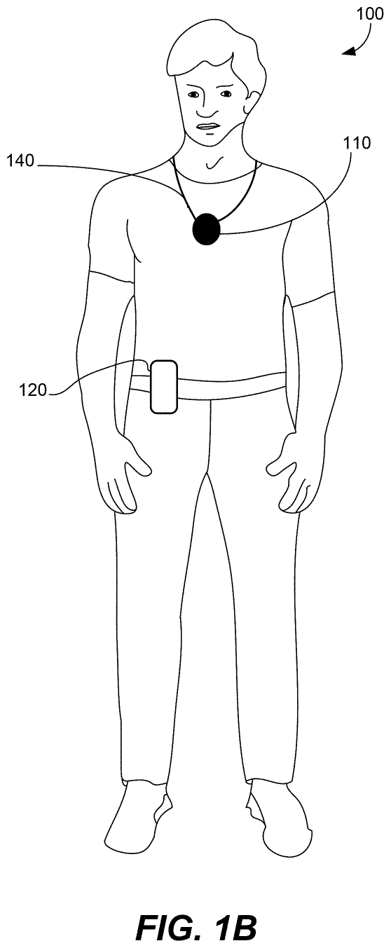

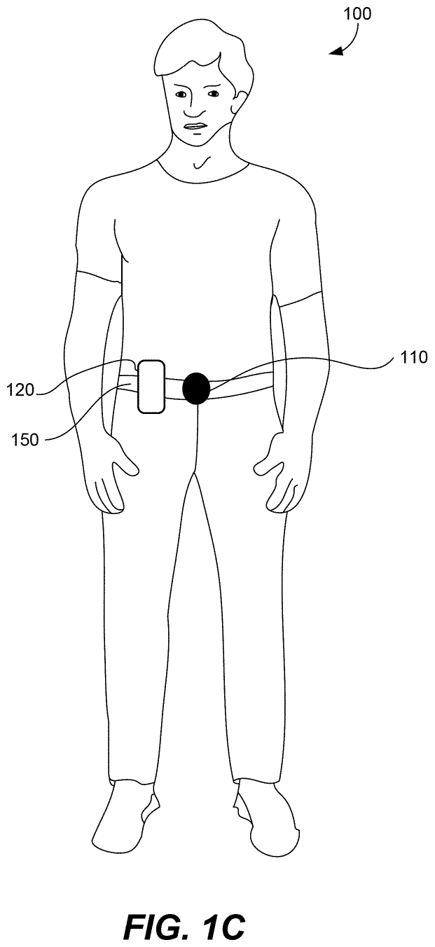

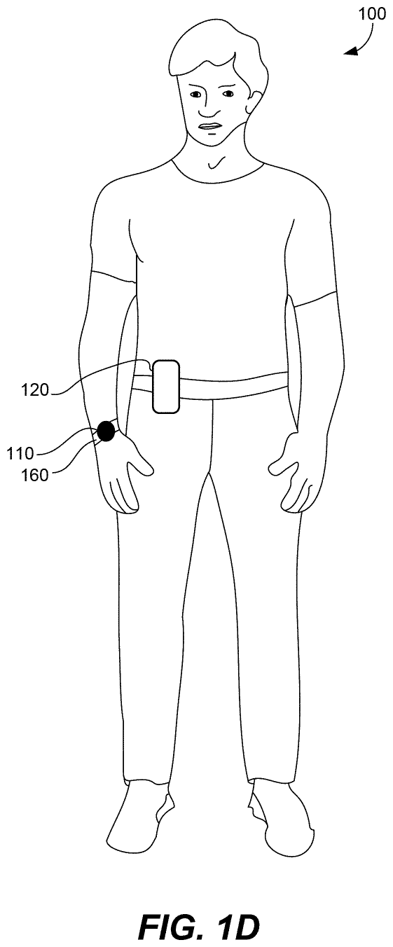

FIG. 1A illustrates a user 100 wearing an apparatus 110 that is physically connected (or integral) to glasses 130, consistent with the disclosed embodiments. Glasses 130 may be prescription glasses, magnifying glasses, non-prescription glasses, safety glasses, sunglasses, etc. Additionally, in some embodiments, glasses 130 may include parts of a frame and earpieces, nosepieces, etc., and one or no lenses. Thus, in some embodiments, glasses 130 may function primarily to support apparatus 110, and/or an augmented reality display device or other optical display device. In some embodiments, apparatus 110 may include an image sensor (not shown in FIG. 1A) for capturing real-time image data of the field-of-view of user 100. The term “image data” includes any form of data retrieved from optical signals in the near-infrared, infrared, visible, and ultraviolet spectrums. The image data may include video clips and/or photographs.

In some embodiments, apparatus 110 may communicate wirelessly or via a wire with a computing device 120. In some embodiments, computing device 120 may include, for example, a smartphone, or a tablet, or a dedicated processing unit, which may be portable (e.g., can be carried in a pocket of user 100). Although shown in FIG. 1A as an external device, in some embodiments, computing device 120 may be provided as part of wearable apparatus 110 or glasses 130, whether integral thereto or mounted thereon. In some embodiments, computing device 120 may be included in an augmented reality display device or optical head mounted display provided integrally or mounted to glasses 130. In other embodiments, computing device 120 may be provided as part of another wearable or portable apparatus of user 100 including a wrist-strap, a multifunctional watch, a button, a clip-on, etc. And in other embodiments, computing device 120 may be provided as part of another system, such as an on-board automobile computing or navigation system. A person skilled in the art can appreciate that different types of computing devices and arrangements of devices may implement the functionality of the disclosed embodiments. Accordingly, in other implementations, computing device 120 may include a Personal Computer (PC), laptop, an Internet server, etc.

FIG. 1B illustrates user 100 wearing apparatus 110 that is physically connected to a necklace 140, consistent with a disclosed embodiment. Such a configuration of apparatus 110 may be suitable for users that do not wear glasses some or all of the time. In this embodiment, user 100 can easily wear apparatus 110, and take it off.

FIG. 1C illustrates user 100 wearing apparatus 110 that is physically connected to a belt 150, consistent with a disclosed embodiment. Such a configuration of apparatus 110 may be designed as a belt buckle. Alternatively, apparatus 110 may include a clip for attaching to various clothing articles, such as belt 150, or a vest, a pocket, a collar, a cap or hat or other portion of a clothing article.

FIG. 1D illustrates user 100 wearing apparatus 110 that is physically connected to a wrist strap 160, consistent with a disclosed embodiment. Although the aiming direction of apparatus 110, according to this embodiment, may not match the field-of-view of user 100, apparatus 110 may include the ability to identify a hand-related trigger based on the tracked eye movement of a user 100 indicating that user 100 is looking in the direction of the wrist strap 160. Wrist strap 160 may also include an accelerometer, a gyroscope, or other sensor for determining movement or orientation of a user's 100 hand for identifying a hand-related trigger.

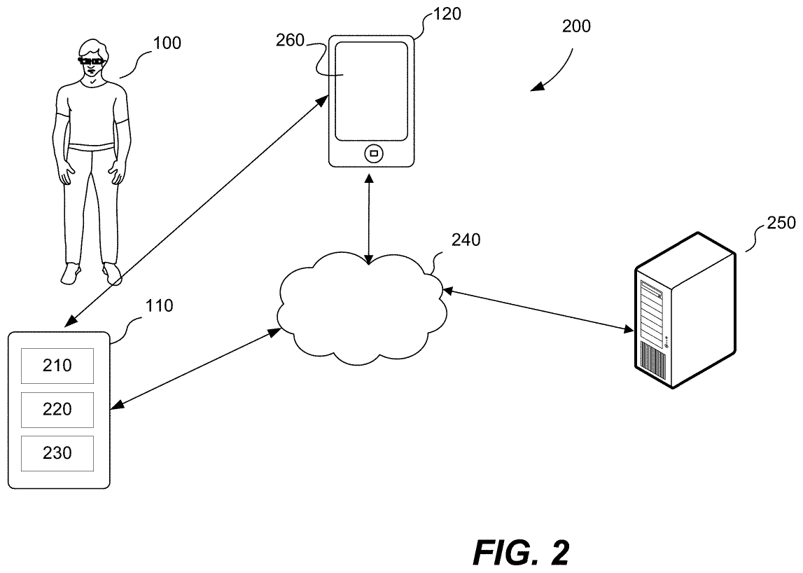

FIG. 2 is a schematic illustration of an exemplary system 200 including a wearable apparatus 110, worn by user 100, and an optional computing device 120 and/or a server 250 capable of communicating with apparatus 110 via a network 240, consistent with disclosed embodiments. In some embodiments, apparatus 110 may capture and analyze image data, identify a hand-related trigger present in the image data, and perform an action and/or provide feedback to a user 100, based at least in part on the identification of the hand-related trigger. In some embodiments, optional computing device 120 and/or server 250 may provide additional functionality to enhance interactions of user 100 with his or her environment, as described in greater detail below.

According to the disclosed embodiments, apparatus 110 may include an image sensor system 220 for capturing real-time image data of the field-of-view of user 100. In some embodiments, apparatus 110 may also include a processing unit 210 for controlling and performing the disclosed functionality of apparatus 110, such as to control the capture of image data, analyze the image data, and perform an action and/or output a feedback based on a hand-related trigger identified in the image data. According to the disclosed embodiments, a hand-related trigger may include a gesture performed by user 100 involving a portion of a hand of user 100. Further, consistent with some embodiments, a hand-related trigger may include a wrist-related trigger. Additionally, in some embodiments, apparatus 110 may include a feedback outputting unit 230 for producing an output of information to user 100.

As discussed above, apparatus 110 may include an image sensor 220 for capturing image data. The term “image sensor” refers to a device capable of detecting and converting optical signals in the near-infrared, infrared, visible, and ultraviolet spectrums into electrical signals. The electrical signals may be used to form an image or a video stream (i.e., image data) based on the detected signal. The term “image data” includes any form of data retrieved from optical signals in the near-infrared, infrared, visible, and ultraviolet spectrums. Examples of image sensors may include semiconductor charge-coupled devices (CCD), active pixel sensors in complementary metal-oxide-semiconductor (CMOS), or N-type metal-oxide-semiconductor (NMOS, Live MOS). In some cases, image sensor 220 may be part of a camera included in apparatus 110.

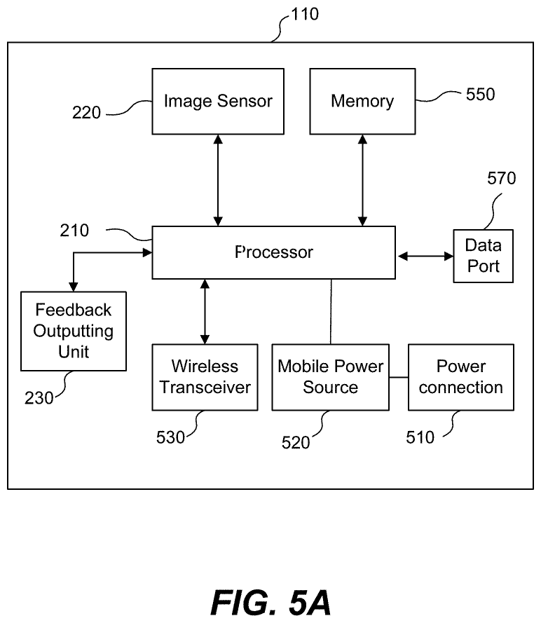

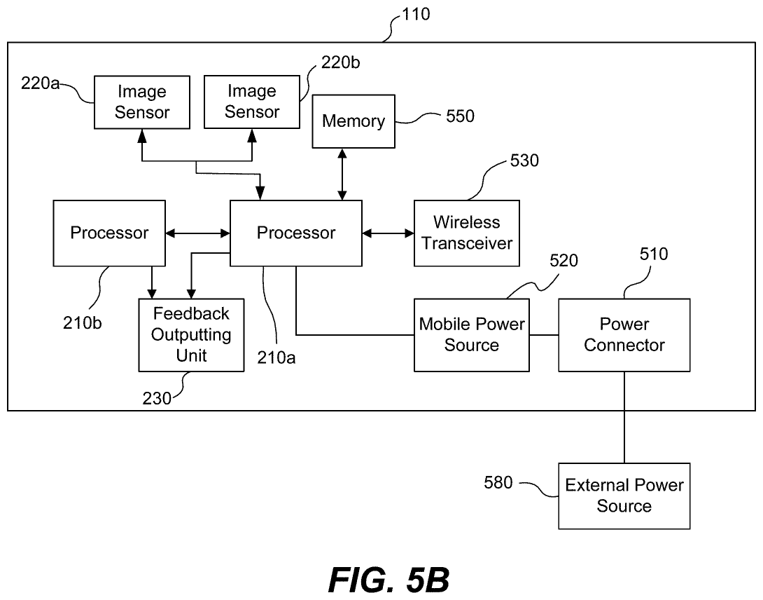

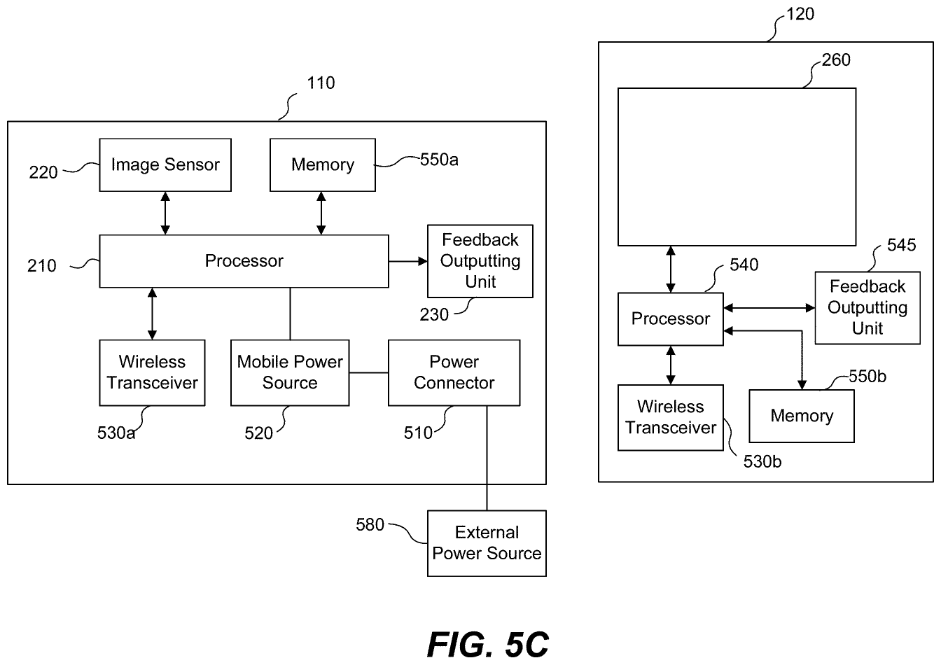

Apparatus 110 may also include a processor 210 for controlling image sensor 220 to capture image data and for analyzing the image data according to the disclosed embodiments. As discussed in further detail below with respect to FIG. 5A, processor 210 may include a “processing device” for performing logic operations on one or more inputs of image data and other data according to stored or accessible software instructions providing desired functionality. In some embodiments, processor 210 may also control feedback outputting unit 230 to provide feedback to user 100 including information based on the analyzed image data and the stored software instructions. As the term is used herein, a “processing device” may access memory where executable instructions are stored or, in some embodiments, a “processing device” itself may include executable instructions (e.g., stored in memory included in the processing device).

In some embodiments, the information or feedback information provided to user 100 may include time information. The time information may include any information related to a current time of day and as described further below, may be presented in any sensory perceptive manner. In some embodiments, time information may include a current time of day in a preconfigured format (e.g., 2:30 pm or 14:30). Time information may include the time in the user's current time zone (e.g., based on a determined location of user 100), as well as an indication of the time zone and/or a time of day in another desired location. In some embodiments, time information may include a number of hours or minutes relative to one or more predetermined times of day. For example, in some embodiments, time information may include an indication that three hours and fifteen minutes remain until a particular hour (e.g., until 6:00 pm), or some other predetermined time. Time information may also include a duration of time passed since the beginning of a particular activity, such as the start of a meeting or the start of a jog, or any other activity. In some embodiments, the activity may be determined based on analyzed image data. In other embodiments, time information may also include additional information related to a current time and one or more other routine, periodic, or scheduled events. For example, time information may include an indication of the number of minutes remaining until the next scheduled event, as may be determined from a calendar function or other information retrieved from computing device 120 or server 250, as discussed in further detail below.

Feedback outputting unit 230 may include one or more feedback systems for providing the output of information to user 100. In the disclosed embodiments, the audible or visual feedback may be provided via any type of connected audible or visual system or both. Feedback of information according to the disclosed embodiments may include audible feedback to user 100 (e.g., using a Bluetooth™ or other wired or wirelessly connected speaker, or a bone conduction headphone). Feedback outputting unit 230 of some embodiments may additionally or alternatively produce a visible output of information to user 100, for example, as part of an augmented reality display projected onto a lens of glasses 130 or provided via a separate heads up display in communication with apparatus 110, such as a display 260 provided as part of computing device 120, which may include an onboard automobile heads up display, an augmented reality device, a virtual reality device, a smartphone, PC, table, etc.

The term “computing device” refers to a device including a processing unit and having computing capabilities. Some examples of computing device 120 include a PC, laptop, tablet, or other computing systems such as an on-board computing system of an automobile, for example, each configured to communicate directly with apparatus 110 or server 250 over network 240. Another example of computing device 120 includes a smartphone having a display 260. In some embodiments, computing device 120 may be a computing system configured particularly for apparatus 110, and may be provided integral to apparatus 110 or tethered thereto. Apparatus 110 can also connect to computing device 120 over network 240 via any known wireless standard (e.g., Wi-Fi, Bluetooth®, etc.), as well as near-filed capacitive coupling, and other short range wireless techniques, or via a wired connection. In an embodiment in which computing device 120 is a smartphone, computing device 120 may have a dedicated application installed therein. For example, user 100 may view on display 260 data (e.g., images, video clips, extracted information, feedback information, etc.) that originate from or are triggered by apparatus 110. In addition, user 100 may select part of the data for storage in server 250.

Network 240 may be a shared, public, or private network, may encompass a wide area or local area, and may be implemented through any suitable combination of wired and/or wireless communication networks. Network 240 may further comprise an intranet or the Internet. In some embodiments, network 240 may include short range or near-field wireless communication systems for enabling communication between apparatus 110 and computing device 120 provided in proximity to each other, such as on or near a user's person, for example. Apparatus 110 may establish a connection to network 240 autonomously, for example, using a wireless module (e.g., Wi-Fi, cellular). In some embodiments, apparatus 110 may use the wireless module when being connected to an external power source, to prolong battery life. Further, communication between apparatus 110 and server 250 may be accomplished through any suitable communication channels, such as, for example, a telephone network, an extranet, an intranet, the Internet, satellite communications, off-line communications, wireless communications, transponder communications, a local area network (LAN), a wide area network (WAN), and a virtual private network (VPN).

As shown in FIG. 2, apparatus 110 may transfer or receive data to/from server 250 via network 240. In the disclosed embodiments, the data being received from server 250 and/or computing device 120 may include numerous different types of information based on the analyzed image data, including information related to a commercial product, or a person's identity, an identified landmark, and any other information capable of being stored in or accessed by server 250. In some embodiments, data may be received and transferred via computing device 120. Server 250 and/or computing device 120 may retrieve information from different data sources (e.g., a user specific database or a user's social network account or other account, the Internet, and other managed or accessible databases) and provide information to apparatus 110 related to the analyzed image data and a recognized trigger according to the disclosed embodiments. In some embodiments, calendar-related information retrieved from the different data sources may be analyzed to provide certain time information or a time-based context for providing certain information based on the analyzed image data.

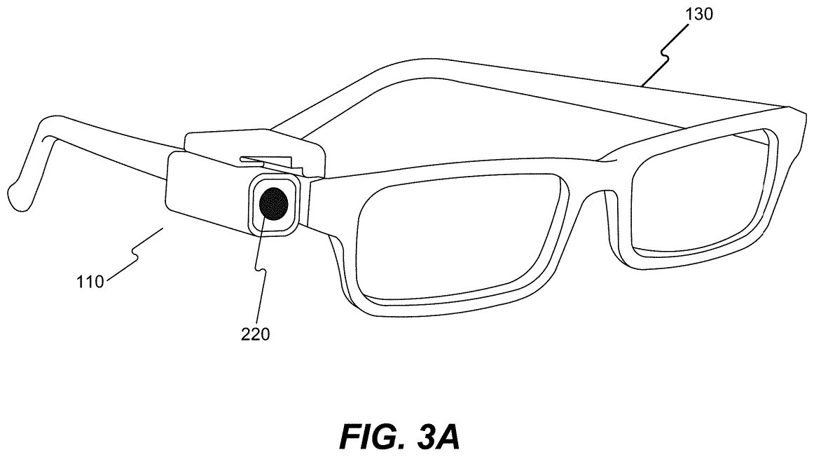

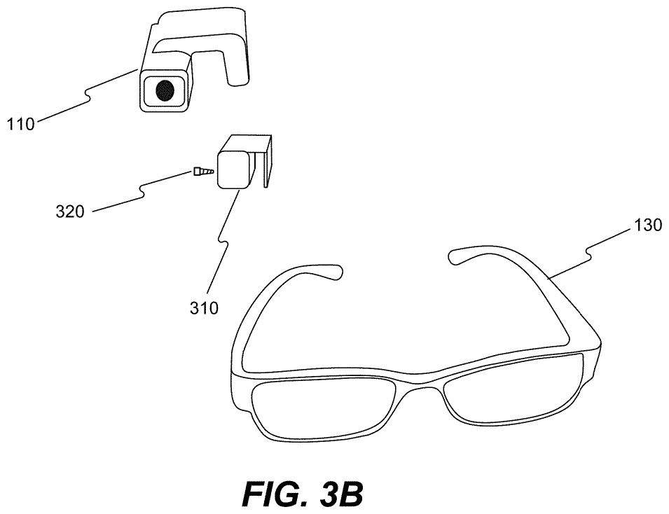

An example of wearable apparatus 110 incorporated with glasses 130 according to some embodiments (as discussed in connection with FIG. 1A) is shown in greater detail in FIG. 3A. In some embodiments, apparatus 110 may be associated with a structure (not shown in FIG. 3A) that enables easy detaching and reattaching of apparatus 110 to glasses 130. In some embodiments, when apparatus 110 attaches to glasses 130, image sensor 220 acquires a set aiming direction without the need for directional calibration. The set aiming direction of image sensor 220 may substantially coincide with the field-of-view of user 100. For example, a camera associated with image sensor 220 may be installed within apparatus 110 in a predetermined angle in a position facing slightly downwards (e.g., 5-15 degrees from the horizon). Accordingly, the set aiming direction of image sensor 220 may substantially match the field-of-view of user 100.

FIG. 3B is an exploded view of the components of the embodiment discussed regarding FIG. 3A. Attaching apparatus 110 to glasses 130 may take place in the following way. Initially, a support 310 may be mounted on glasses 130 using a screw 320, in the side of support 310. Then, apparatus 110 may be clipped on support 310 such that it is aligned with the field-of-view of user 100. The term “support” includes any device or structure that enables detaching and reattaching of a device including a camera to a pair of glasses or to another object (e.g., a helmet). Support 310 may be made from plastic (e.g., polycarbonate), metal (e.g., aluminum), or a combination of plastic and metal (e.g., carbon fiber graphite). Support 310 may be mounted on any kind of glasses (e.g., eyeglasses, sunglasses, 3D glasses, safety glasses, etc.) using screws, bolts, snaps, or any fastening means used in the art.

In some embodiments, support 310 may include a quick release mechanism for disengaging and reengaging apparatus 110. For example, support 310 and apparatus 110 may include magnetic elements. As an alternative example, support 310 may include a male latch member and apparatus 110 may include a female receptacle. In other embodiments, support 310 can be an integral part of a pair of glasses, or sold separately and installed by an optometrist. For example, support 310 may be configured for mounting on the arms of glasses 130 near the frame front, but before the hinge. Alternatively, support 310 may be configured for mounting on the bridge of glasses 130.

In some embodiments, apparatus 110 may be provided as part of a glasses frame 130, with or without lenses. Additionally, in some embodiments, apparatus 110 may be configured to provide an augmented reality display projected onto a lens of glasses 130 (if provided), or alternatively, may include a display for projecting time information, for example, according to the disclosed embodiments. Apparatus 110 may include the additional display or alternatively, may be in communication with a separately provided display system that may or may not be attached to glasses 130.

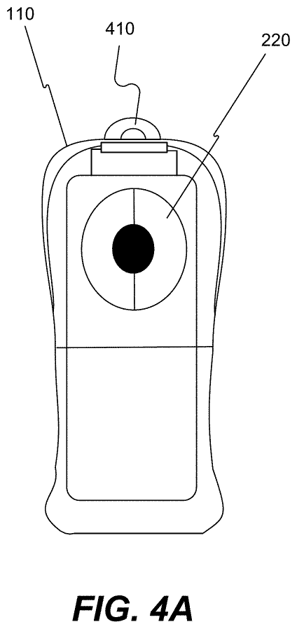

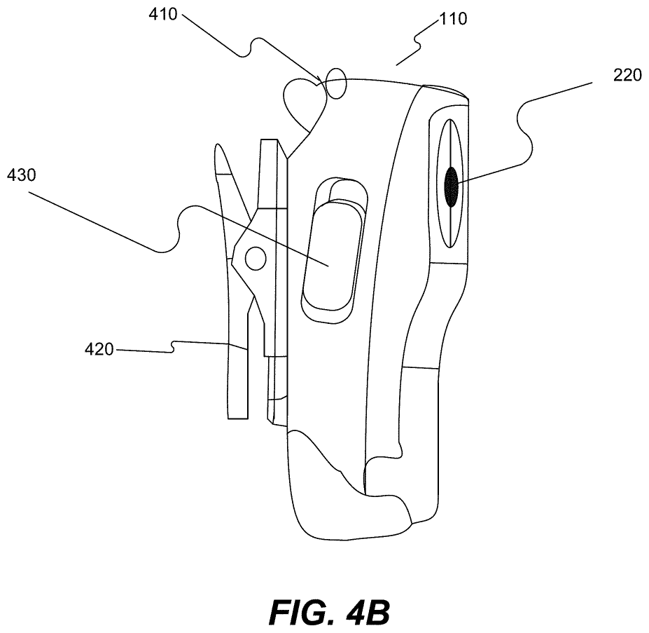

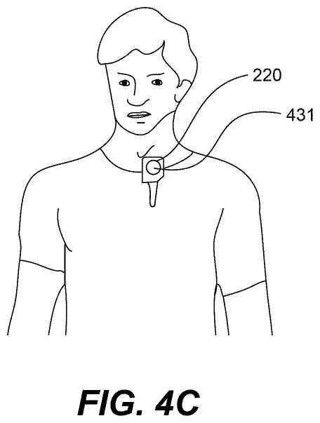

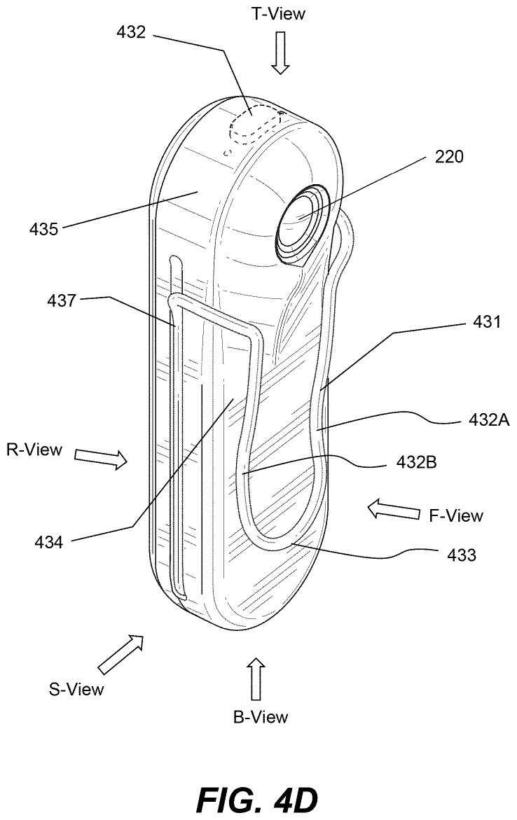

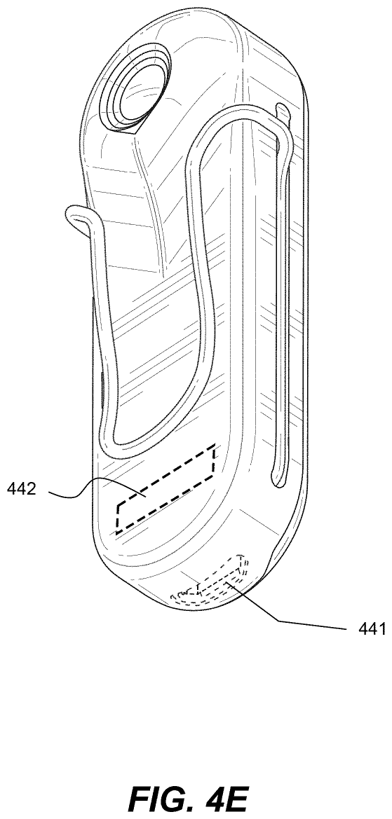

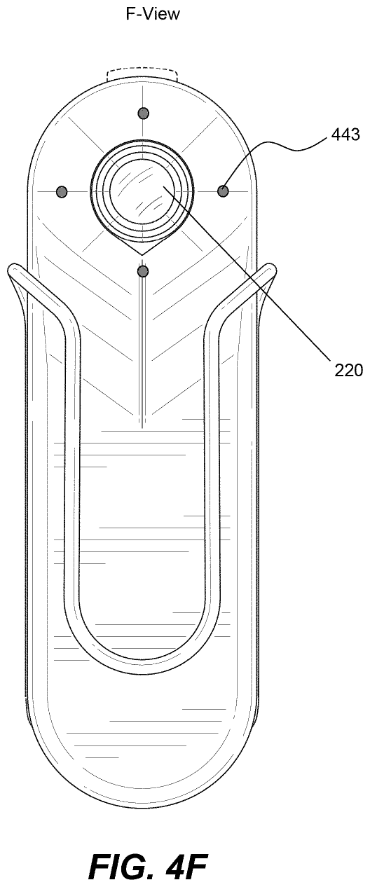

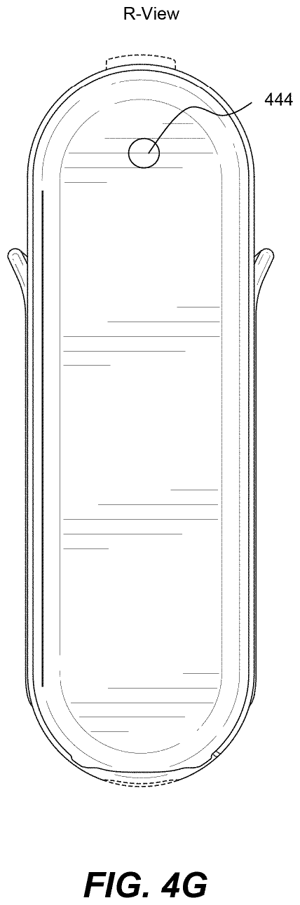

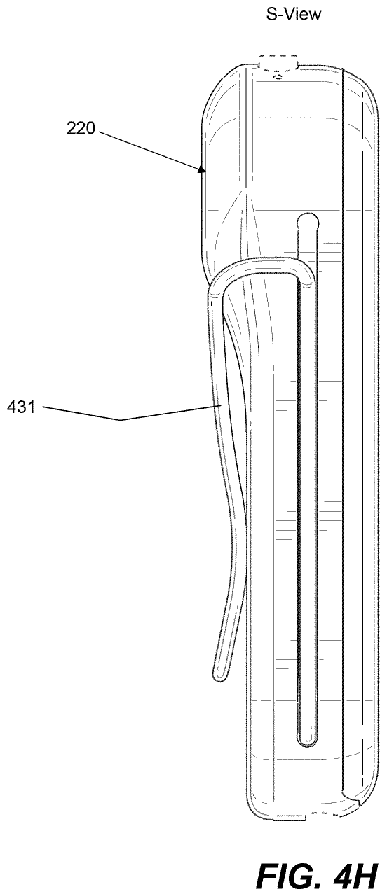

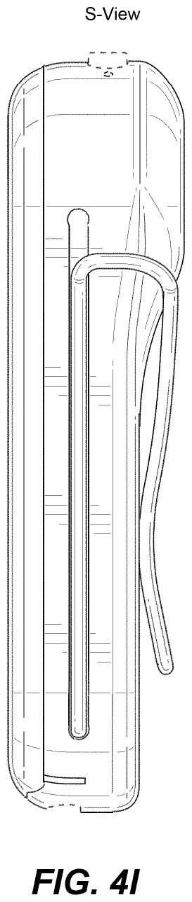

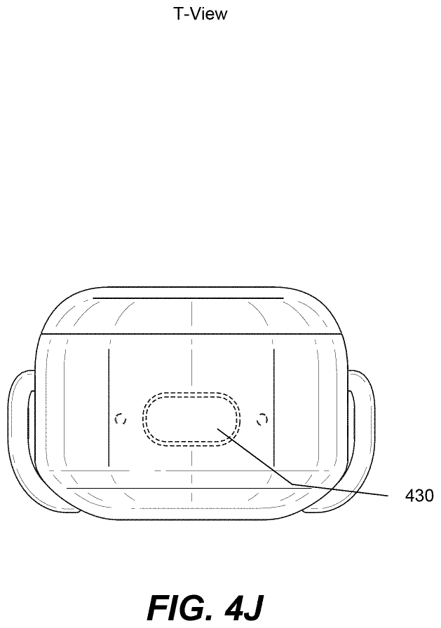

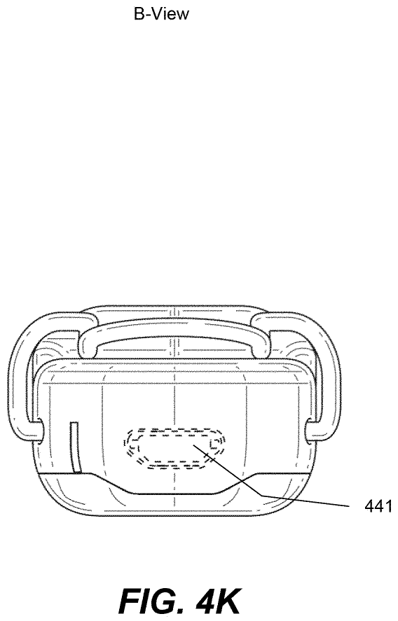

In some embodiments, apparatus 110 may be implemented in a form other than wearable glasses, as described above with respect to FIGS. 1B-1D, for example. FIG. 4A is a schematic illustration of an example of an additional embodiment of apparatus 110 from a front viewpoint of apparatus 110. Apparatus 110 includes an image sensor 220, a clip (not shown), a function button (not shown) and a hanging ring 410 for attaching apparatus 110 to, for example, necklace 140, as shown in FIG. 1B. When apparatus 110 hangs on necklace 140, the aiming direction of image sensor 220 may not fully coincide with the field-of-view of user 100, but the aiming direction would still correlate with the field-of-view of user 100.

FIG. 4B is a schematic illustration of the example of a second embodiment of apparatus 110, from a side orientation of apparatus 110. In addition to hanging ring 410, as shown in FIG. 4B, apparatus 110 may further include a clip 420. User 100 can use clip 420 to attach apparatus 110 to a shirt or belt 150, as illustrated in FIG. 1C. Clip 420 may provide an easy mechanism for disengaging and re-engaging apparatus 110 from different articles of clothing. In other embodiments, apparatus 110 may include a female receptacle for connecting with a male latch of a car mount or universal stand.

In some embodiments, apparatus 110 includes a function button 430 for enabling user 100 to provide input to apparatus 110. Function button 430 may accept different types of tactile input (e.g., a tap, a click, a double-click, a long press, a right-to-left slide, a left-to-right slide). In some embodiments, each type of input may be associated with a different action. For example, a tap may be associated with the function of taking a picture, while a right-to-left slide may be associated with the function of recording a video.

Apparatus 110 may be attached to an article of clothing (e.g., a shirt, a belt, pants, etc.), of user 100 at an edge of the clothing using a clip 431 as shown in FIG. 4C. For example, the body of apparatus 100 may reside adjacent to the inside surface of the clothing with clip 431 engaging with the outside surface of the clothing. In such an embodiment, as shown in FIG. 4C, the image sensor 220 (e.g., a camera for visible light) may be protruding beyond the edge of the clothing. Alternatively, clip 431 may be engaging with the inside surface of the clothing with the body of apparatus 110 being adjacent to the outside of the clothing. In various embodiments, the clothing may be positioned between clip 431 and the body of apparatus 110.

An example embodiment of apparatus 110 is shown in FIG. 4D. Apparatus 110 includes clip 431 which may include points (e.g., 432A and 432B) in close proximity to a front surface 434 of a body 435 of apparatus 110. In an example embodiment, the distance between points 432A, 432B and front surface 434 may be less than a typical thickness of a fabric of the clothing of user 100. For example, the distance between points 432A, 432B and surface 434 may be less than a thickness of a tee-shirt, e.g., less than a millimeter, less than 2 millimeters, less than 3 millimeters, etc., or, in some cases, points 432A, 432B of clip 431 may touch surface 434. In various embodiments, clip 431 may include a point 433 that does not touch surface 434, allowing the clothing to be inserted between clip 431 and surface 434.

FIG. 4D shows schematically different views of apparatus 110 defined as a front view (F-view), a rearview (R-view), a top view (T-view), a side view (S-view) and a bottom view (B-view). These views will be referred to when describing apparatus 110 in subsequent figures. FIG. 4D shows an example embodiment where clip 431 is positioned at the same side of apparatus 110 as sensor 220 (e.g., the front side of apparatus 110). Alternatively, clip 431 may be positioned at an opposite side of apparatus 110 as sensor 220 (e.g., the rear side of apparatus 110). In various embodiments, apparatus 110 may include function button 430, as shown in FIG. 4D.

Various views of apparatus 110 are illustrated in FIGS. 4E through 4K. For example, FIG. 4E shows a view of apparatus 110 with an electrical connection 441. Electrical connection 441 may be, for example, a USB port, that may be used to transfer data to/from apparatus 110 and provide electrical power to apparatus 110. In an example embodiment, connection 441 may be used to charge a battery 442 schematically shown in FIG. 4E. FIG. 4F shows F-view of apparatus 110, including sensor 220 and one or more microphones 443. In some embodiments, apparatus 110 may include several microphones 443 facing outwards, wherein microphones 443 are configured to obtain environmental sounds and sounds of various speakers communicating with user 100. FIG. 4G shows R-view of apparatus 110. In some embodiments, microphone 444 may be positioned at the rear side of apparatus 110, as shown in FIG. 4G. Microphone 444 may be used to detect an audio signal from user 100. It should be noted that apparatus 110 may have microphones placed at any side (e.g., a front side, a rear side, a left side, a right side, a top side, or a bottom side) of apparatus 110. In various embodiments, some microphones may be at a first side (e.g., microphones 443 may be at the front of apparatus 110) and other microphones may be at a second side (e.g., microphone 444 may be at the back side of apparatus 110).

FIGS. 4H and 4I show different sides of apparatus 110 (i.e., S-view of apparatus 110) consisted with disclosed embodiments. For example, FIG. 4H shows the location of sensor 220 and an example shape of clip 431. FIG. 4J shows T-view of apparatus 110, including function button 430, and FIG. 4K shows B-view of apparatus 110 with electrical connection 441.

The example embodiments discussed above with respect to FIGS. 3A, 3B, 4A, and 4B are not limiting. In some embodiments, apparatus 110 may be implemented in any suitable configuration for performing the disclosed methods. For example, referring back to FIG. 2, the disclosed embodiments may implement an apparatus 110 according to any configuration including an image sensor 220 and a processor unit 210 to perform image analysis and for communicating with a feedback unit 230.

FIG. 5A is a block diagram illustrating the components of apparatus 110 according to an example embodiment. As shown in FIG. 5A, and as similarly discussed above, apparatus 110 includes an image sensor 220, a memory 550, a processor 210, a feedback outputting unit 230, a wireless transceiver 530, and a mobile power source 520. In other embodiments, apparatus 110 may also include buttons, other sensors such as a microphone, and inertial measurements devices such as accelerometers, gyroscopes, magnetometers, temperature sensors, color sensors, light sensors, etc. Apparatus 110 may further include a data port 570 and a power connection 510 with suitable interfaces for connecting with an external power source or an external device (not shown).

Processor 210, depicted in FIG. 5A, may include any suitable processing device. The term “processing device” includes any physical device having an electric circuit that performs a logic operation on input or inputs. For example, processing device may include one or more integrated circuits, microchips, microcontrollers, microprocessors, all or part of a central processing unit (CPU), graphics processing unit (GPU), digital signal processor (DSP), field-programmable gate array (FPGA), or other circuits suitable for executing instructions or performing logic operations. The instructions executed by the processing device may, for example, be pre-loaded into a memory integrated with or embedded into the processing device or may be stored in a separate memory (e.g., memory 550). Memory 550 may comprise a Random Access Memory (RAM), a Read-Only Memory (ROM), a hard disk, an optical disk, a magnetic medium, a flash memory, other permanent, fixed, or volatile memory, or any other mechanism capable of storing instructions.

Although, in the embodiment illustrated in FIG. 5A, apparatus 110 includes one processing device (e.g., processor 210), apparatus 110 may include more than one processing device. Each processing device may have a similar construction, or the processing devices may be of differing constructions that are electrically connected or disconnected from each other. For example, the processing devices may be separate circuits or integrated in a single circuit. When more than one processing device is used, the processing devices may be configured to operate independently or collaboratively. The processing devices may be coupled electrically, magnetically, optically, acoustically, mechanically or by other means that permit them to interact.

In some embodiments, processor 210 may process a plurality of images captured from the environment of user 100 to determine different parameters related to capturing subsequent images. For example, processor 210 can determine, based on information derived from captured image data, a value for at least one of the following: an image resolution, a compression ratio, a cropping parameter, frame rate, a focus point, an exposure time, an aperture size, and a light sensitivity. The determined value may be used in capturing at least one subsequent image. Additionally, processor 210 can detect images including at least one hand-related trigger in the environment of the user and perform an action and/or provide an output of information to a user via feedback outputting unit 230.

In another embodiment, processor 210 can change the aiming direction of image sensor 220. For example, when apparatus 110 is attached with clip 420, the aiming direction of image sensor 220 may not coincide with the field-of-view of user 100. Processor 210 may recognize certain situations from the analyzed image data and adjust the aiming direction of image sensor 220 to capture relevant image data. For example, in one embodiment, processor 210 may detect an interaction with another individual and sense that the individual is not fully in view, because image sensor 220 is tilted down. Responsive thereto, processor 210 may adjust the aiming direction of image sensor 220 to capture image data of the individual. Other scenarios are also contemplated where processor 210 may recognize the need to adjust an aiming direction of image sensor 220.

In some embodiments, processor 210 may communicate data to feedback-outputting unit 230, which may include any device configured to provide information to a user 100. Feedback outputting unit 230 may be provided as part of apparatus 110 (as shown) or may be provided external to apparatus 110 and communicatively coupled thereto. Feedback-outputting unit 230 may be configured to output visual or nonvisual feedback based on signals received from processor 210, such as when processor 210 recognizes a hand-related trigger in the analyzed image data.

The term “feedback” refers to any output or information provided in response to processing at least one image in an environment. In some embodiments, as similarly described above, feedback may include an audible or visible indication of time information, detected text or numerals, the value of currency, a branded product, a person's identity, the identity of a landmark or other environmental situation or condition including the street names at an intersection or the color of a traffic light, etc., as well as other information associated with each of these. For example, in some embodiments, feedback may include additional information regarding the amount of currency still needed to complete a transaction, information regarding the identified person, historical information or times and prices of admission etc. of a detected landmark etc. In some embodiments, feedback may include an audible tone, a tactile response, and/or information previously recorded by user 100. Feedback-outputting unit 230 may comprise appropriate components for outputting acoustical and tactile feedback. For example, feedback-outputting unit 230 may comprise audio headphones, a hearing aid type device, a speaker, a bone conduction headphone, interfaces that provide tactile cues, vibrotactile stimulators, etc. In some embodiments, processor 210 may communicate signals with an external feedback outputting unit 230 via a wireless transceiver 530, a wired connection, or some other communication interface. In some embodiments, feedback outputting unit 230 may also include any suitable display device for visually displaying information to user 100.

As shown in FIG. 5A, apparatus 110 includes memory 550. Memory 550 may include one or more sets of instructions accessible to processor 210 to perform the disclosed methods, including instructions for recognizing a hand-related trigger in the image data. In some embodiments memory 550 may store image data (e.g., images, videos) captured from the environment of user 100. In addition, memory 550 may store information specific to user 100, such as image representations of known individuals, favorite products, personal items, and calendar or appointment information, etc. In some embodiments, processor 210 may determine, for example, which type of image data to store based on available storage space in memory 550. In another embodiment, processor 210 may extract information from the image data stored in memory 550.

As further shown in FIG. 5A, apparatus 110 includes mobile power source 520. The term “mobile power source” includes any device capable of providing electrical power, which can be easily carried by hand (e.g., mobile power source 520 may weigh less than a pound). The mobility of the power source enables user 100 to use apparatus 110 in a variety of situations. In some embodiments, mobile power source 520 may include one or more batteries (e.g., nickel-cadmium batteries, nickel-metal hydride batteries, and lithium-ion batteries) or any other type of electrical power supply. In other embodiments, mobile power source 520 may be rechargeable and contained within a casing that holds apparatus 110. In yet other embodiments, mobile power source 520 may include one or more energy harvesting devices for converting ambient energy into electrical energy (e.g., portable solar power units, human vibration units, etc.).

Mobile power source 520 may power one or more wireless transceivers (e.g., wireless transceiver 530 in FIG. 5A). The term “wireless transceiver” refers to any device configured to exchange transmissions over an air interface by use of radio frequency, infrared frequency, magnetic field, or electric field. Wireless transceiver 530 may use any known standard to transmit and/or receive data (e.g., Wi-Fi, Bluetooth®, Bluetooth Smart, 802.15.4, or ZigBee). In some embodiments, wireless transceiver 530 may transmit data (e.g., raw image data, processed image data, extracted information) from apparatus 110 to computing device 120 and/or server 250. Wireless transceiver 530 may also receive data from computing device 120 and/or server 250. In other embodiments, wireless transceiver 530 may transmit data and instructions to an external feedback outputting unit 230.

FIG. 5B is a block diagram illustrating the components of apparatus 110 according to another example embodiment. In some embodiments, apparatus 110 includes a first image sensor 220a, a second image sensor 220b, a memory 550, a first processor 210a, a second processor 210b, a feedback outputting unit 230, a wireless transceiver 530, a mobile power source 520, and a power connector 510. In the arrangement shown in FIG. 5B, each of the image sensors may provide images in a different image resolution, or face a different direction. Alternatively, each image sensor may be associated with a different camera (e.g., a wide angle camera, a narrow angle camera, an IR camera, etc.). In some embodiments, apparatus 110 can select which image sensor to use based on various factors. For example, processor 210a may determine, based on available storage space in memory 550, to capture subsequent images in a certain resolution.

Apparatus 110 may operate in a first processing-mode and in a second processing-mode, such that the first processing-mode may consume less power than the second processing-mode. For example, in the first processing-mode, apparatus 110 may capture images and process the captured images to make real-time decisions based on an identifying hand-related trigger, for example. In the second processing-mode, apparatus 110 may extract information from stored images in memory 550 and delete images from memory 550. In some embodiments, mobile power source 520 may provide more than fifteen hours of processing in the first processing-mode and about three hours of processing in the second processing-mode. Accordingly, different processing-modes may allow mobile power source 520 to produce sufficient power for powering apparatus 110 for various time periods (e.g., more than two hours, more than four hours, more than ten hours, etc.).

In some embodiments, apparatus 110 may use first processor 210a in the first processing-mode when powered by mobile power source 520, and second processor 210b in the second processing-mode when powered by external power source 580 that is connectable via power connector 510. In other embodiments, apparatus 110 may determine, based on predefined conditions, which processors or which processing modes to use. Apparatus 110 may operate in the second processing-mode even when apparatus 110 is not powered by external power source 580. For example, apparatus 110 may determine that it should operate in the second processing-mode when apparatus 110 is not powered by external power source 580, if the available storage space in memory 550 for storing new image data is lower than a predefined threshold.

Although one wireless transceiver is depicted in FIG. 5B, apparatus 110 may include more than one wireless transceiver (e.g., two wireless transceivers). In an arrangement with more than one wireless transceiver, each of the wireless transceivers may use a different standard to transmit and/or receive data. In some embodiments, a first wireless transceiver may communicate with server 250 or computing device 120 using a cellular standard (e.g., LTE or GSM), and a second wireless transceiver may communicate with server 250 or computing device 120 using a short-range standard (e.g., Wi-Fi or Bluetooth®). In some embodiments, apparatus 110 may use the first wireless transceiver when the wearable apparatus is powered by a mobile power source included in the wearable apparatus, and use the second wireless transceiver when the wearable apparatus is powered by an external power source.

FIG. 5C is a block diagram illustrating the components of apparatus 110 according to another example embodiment including computing device 120. In this embodiment, apparatus 110 includes an image sensor 220, a memory 550a, a first processor 210, a feedback-outputting unit 230, a wireless transceiver 530a, a mobile power source 520, and a power connector 510. As further shown in FIG. 5C, computing device 120 includes a processor 540, a feedback-outputting unit 545, a memory 550b, a wireless transceiver 530b, and a display 260. One example of computing device 120 is a smartphone or tablet having a dedicated application installed therein. In other embodiments, computing device 120 may include any configuration such as an on-board automobile computing system, a PC, a laptop, and any other system consistent with the disclosed embodiments. In this example, user 100 may view feedback output in response to identification of a hand-related trigger on display 260. Additionally, user 100 may view other data (e.g., images, video clips, object information, schedule information, extracted information, etc.) on display 260. In addition, user 100 may communicate with server 250 via computing device 120.

In some embodiments, processor 210 and processor 540 are configured to extract information from captured image data. The term “extracting information” includes any process by which information associated with objects, individuals, locations, events, etc., is identified in the captured image data by any means known to those of ordinary skill in the art. In some embodiments, apparatus 110 may use the extracted information to send feedback or other real-time indications to feedback outputting unit 230 or to computing device 120. In some embodiments, processor 210 may identify in the image data the individual standing in front of user 100, and send computing device 120 the name of the individual and the last time user 100 met the individual. In another embodiment, processor 210 may identify in the image data, one or more visible triggers, including a hand-related trigger, and determine whether the trigger is associated with a person other than the user of the wearable apparatus to selectively determine whether to perform an action associated with the trigger. One such action may be to provide a feedback to user 100 via feedback-outputting unit 230 provided as part of (or in communication with) apparatus 110 or via a feedback unit 545 provided as part of computing device 120. For example, feedback-outputting unit 545 may be in communication with display 260 to cause the display 260 to visibly output information. In some embodiments, processor 210 may identify in the image data a hand-related trigger and send computing device 120 an indication of the trigger. Processor 540 may then process the received trigger information and provide an output via feedback outputting unit 545 or display 260 based on the hand-related trigger. In other embodiments, processor 540 may determine a hand-related trigger and provide suitable feedback similar to the above, based on image data received from apparatus 110. In some embodiments, processor 540 may provide instructions or other information, such as environmental information to apparatus 110 based on an identified hand-related trigger.

In some embodiments, processor 210 may identify other environmental information in the analyzed images, such as an individual standing in front user 100, and send computing device 120 information related to the analyzed information such as the name of the individual and the last time user 100 met the individual. In a different embodiment, processor 540 may extract statistical information from captured image data and forward the statistical information to server 250. For example, certain information regarding the types of items a user purchases, or the frequency a user patronizes a particular merchant, etc. may be determined by processor 540. Based on this information, server 250 may send computing device 120 coupons and discounts associated with the user's preferences.

When apparatus 110 is connected or wirelessly connected to computing device 120, apparatus 110 may transmit at least part of the image data stored in memory 550a for storage in memory 550b. In some embodiments, after computing device 120 confirms that transferring the part of image data was successful, processor 540 may delete the part of the image data. The term “delete” means that the image is marked as ‘deleted’ and other image data may be stored instead of it, but does not necessarily mean that the image data was physically removed from the memory.

As will be appreciated by a person skilled in the art having the benefit of this disclosure, numerous variations and/or modifications may be made to the disclosed embodiments. Not all components are essential for the operation of apparatus 110. Any component may be located in any appropriate apparatus and the components may be rearranged into a variety of configurations while providing the functionality of the disclosed embodiments. For example, in some embodiments, apparatus 110 may include a camera, a processor, and a wireless transceiver for sending data to another device. Therefore, the foregoing configurations are examples and, regardless of the configurations discussed above, apparatus 110 can capture, store, and/or process images.

Further, the foregoing and following description refers to storing and/or processing images or image data. In the embodiments disclosed herein, the stored and/or processed images or image data may comprise a representation of one or more images captured by image sensor 220. As the term is used herein, a “representation” of an image (or image data) may include an entire image or a portion of an image. A representation of an image (or image data) may have the same resolution or a lower resolution as the image (or image data), and/or a representation of an image (or image data) may be altered in some respect (e.g., be compressed, have a lower resolution, have one or more colors that are altered, etc.).

For example, apparatus 110 may capture an image and store a representation of the image that is compressed as a JPG file. As another example, apparatus 110 may capture an image in color, but store a black-and-white representation of the color image. As yet another example, apparatus 110 may capture an image and store a different representation of the image (e.g., a portion of the image). For example, apparatus 110 may store a portion of an image that includes a face of a person who appears in the image, but that does not substantially include the environment surrounding the person. Similarly, apparatus 110 may, for example, store a portion of an image that includes a product that appears in the image, but does not substantially include the environment surrounding the product. As yet another example, apparatus 110 may store a representation of an image at a reduced resolution (i.e., at a resolution that is of a lower value than that of the captured image). Storing representations of images may allow apparatus 110 to save storage space in memory 550. Furthermore, processing representations of images may allow apparatus 110 to improve processing efficiency and/or help to preserve battery life.

In addition to the above, in some embodiments, any one of apparatus 110 or computing device 120, via processor 210 or 540, may further process the captured image data to provide additional functionality to recognize objects and/or gestures and/or other information in the captured image data. In some embodiments, actions may be taken based on the identified objects, gestures, or other information. In some embodiments, processors 210 or 540 may identify in the image data, one or more visible triggers, including a hand-related trigger, and determine whether the trigger is associated with a person other than the user to determine whether to perform an action associated with the trigger.

Some embodiments of the present disclosure may include an apparatus securable to an article of clothing of a user. Such an apparatus may include two portions, connectable by a connector. A capturing unit may be designed to be worn on the outside of a user's clothing, and may include an image sensor for capturing images of a user's environment. The capturing unit may be connected to or connectable to a power unit, which may be configured to house a power source and a processing device. The capturing unit may be a small device including a camera or other device for capturing images. The capturing unit may be designed to be inconspicuous and unobtrusive, and may be configured to communicate with a power unit concealed by a user's clothing. The power unit may include bulkier aspects of the system, such as transceiver antennas, at least one battery, a processing device, etc. In some embodiments, communication between the capturing unit and the power unit may be provided by a data cable included in the connector, while in other embodiments, communication may be wirelessly achieved between the capturing unit and the power unit. Some embodiments may permit alteration of the orientation of an image sensor of the capture unit, for example to better capture images of interest.

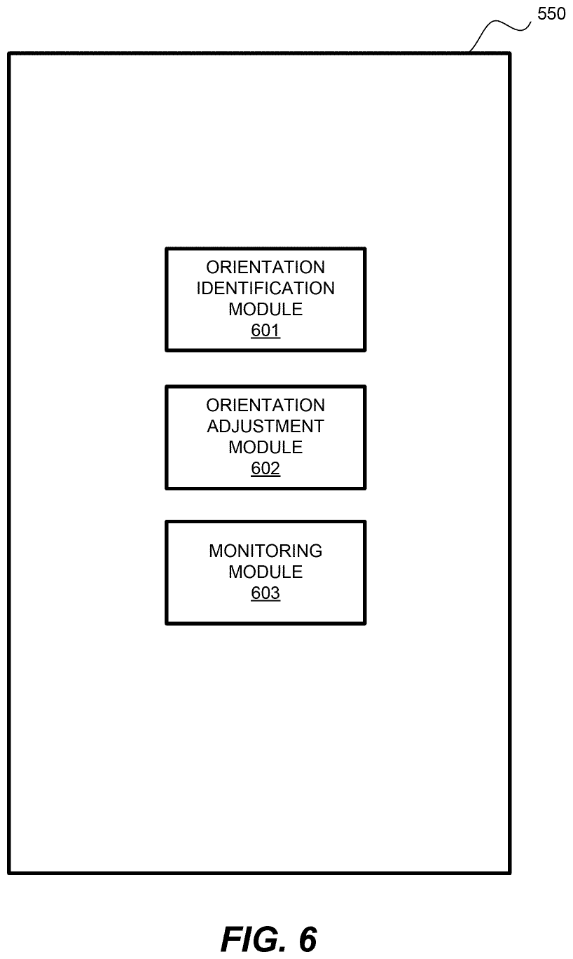

FIG. 6 illustrates an exemplary embodiment of a memory containing software modules consistent with the present disclosure. Included in memory 550 are orientation identification module 601, orientation adjustment module 602, and motion tracking module 603. Modules 601, 602, 603 may contain software instructions for execution by at least one processing device, e.g., processor 210, included with a wearable apparatus. Orientation identification module 601, orientation adjustment module 602, and motion tracking module 603 may cooperate to provide orientation adjustment for a capturing unit incorporated into wireless apparatus 110.

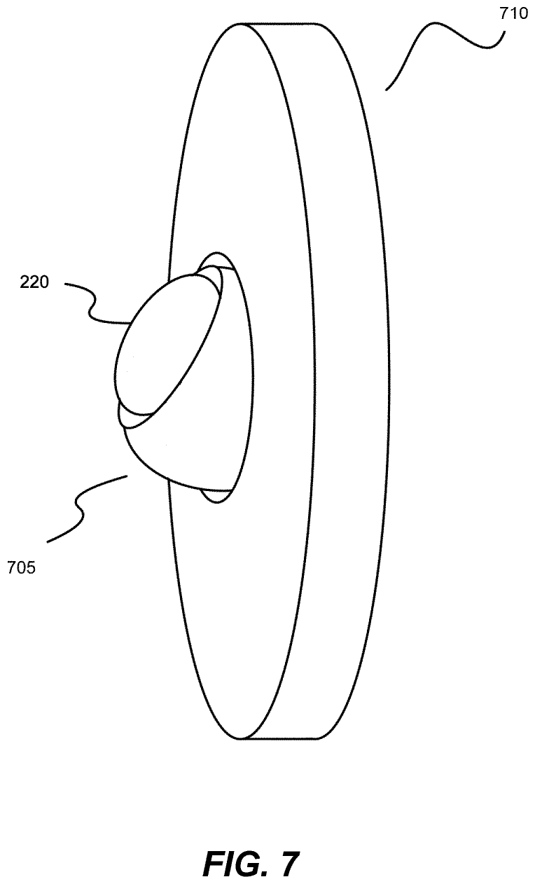

FIG. 7 illustrates an exemplary capturing unit 710 including an orientation adjustment unit 705. Orientation adjustment unit 705 may be configured to permit the adjustment of image sensor 220. As illustrated in FIG. 7, orientation adjustment unit 705 may include an eye-ball type adjustment mechanism. In alternative embodiments, orientation adjustment unit 705 may include gimbals, adjustable stalks, pivotable mounts, and any other suitable unit for adjusting an orientation of image sensor 220.

Image sensor 220 may be configured to be movable with the head of user 100 in such a manner that an aiming direction of image sensor 220 substantially coincides with a field of view of user 100. For example, as described above, a camera associated with image sensor 220 may be installed within capturing unit 710 at a predetermined angle in a position facing slightly upwards or downwards, depending on an intended location of capturing unit 710. Accordingly, the set aiming direction of image sensor 220 may match the field-of-view of user 100. In some embodiments, processor 210 may change the orientation of image sensor 220 using image data provided from image sensor 220. For example, processor 210 may recognize that a user is reading a book and determine that the aiming direction of image sensor 220 is offset from the text. That is, because the words in the beginning of each line of text are not fully in view, processor 210 may determine that image sensor 220 is tilted in the wrong direction. Responsive thereto, processor 210 may adjust the aiming direction of image sensor 220.

Orientation identification module 601 may be configured to identify an orientation of an image sensor 220 of capturing unit 710. An orientation of an image sensor 220 may be identified, for example, by analysis of images captured by image sensor 220 of capturing unit 710, by tilt or attitude sensing devices within capturing unit 710, and by measuring a relative direction of orientation adjustment unit 705 with respect to the remainder of capturing unit 710.

Orientation adjustment module 602 may be configured to adjust an orientation of image sensor 220 of capturing unit 710. As discussed above, image sensor 220 may be mounted on an orientation adjustment unit 705 configured for movement. Orientation adjustment unit 705 may be configured for rotational and/or lateral movement in response to commands from orientation adjustment module 602. In some embodiments orientation adjustment unit 705 may be adjust an orientation of image sensor 220 via motors, electromagnets, permanent magnets, and/or any suitable combination thereof.

In some embodiments, monitoring module 603 may be provided for continuous monitoring. Such continuous monitoring may include tracking a movement of at least a portion of an object included in one or more images captured by the image sensor. For example, in one embodiment, apparatus 110 may track an object as long as the object remains substantially within the field-of-view of image sensor 220. In additional embodiments, monitoring module 603 may engage orientation adjustment module 602 to instruct orientation adjustment unit 705 to continually orient image sensor 220 towards an object of interest. For example, in one embodiment, monitoring module 603 may cause image sensor 220 to adjust an orientation to ensure that a certain designated object, for example, the face of a particular person, remains within the field-of view of image sensor 220, even as that designated object moves about. In another embodiment, monitoring module 603 may continuously monitor an area of interest included in one or more images captured by the image sensor. For example, a user may be occupied by a certain task, for example, typing on a laptop, while image sensor 220 remains oriented in a particular direction and continuously monitors a portion of each image from a series of images to detect a trigger or other event. For example, image sensor 210 may be oriented towards a piece of laboratory equipment and monitoring module 603 may be configured to monitor a status light on the laboratory equipment for a change in status, while the user's attention is otherwise occupied.

In some embodiments consistent with the present disclosure, capturing unit 710 may include a plurality of image sensors 220. The plurality of image sensors 220 may each be configured to capture different image data. For example, when a plurality of image sensors 220 are provided, the image sensors 220 may capture images having different resolutions, may capture wider or narrower fields of view, and may have different levels of magnification. Image sensors 220 may be provided with varying lenses to permit these different configurations. In some embodiments, a plurality of image sensors 220 may include image sensors 220 having different orientations. Thus, each of the plurality of image sensors 220 may be pointed in a different direction to capture different images. The fields of view of image sensors 220 may be overlapping in some embodiments. The plurality of image sensors 220 may each be configured for orientation adjustment, for example, by being paired with an image adjustment unit 705. In some embodiments, monitoring module 603, or another module associated with memory 550, may be configured to individually adjust the orientations of the plurality of image sensors 220 as well as to turn each of the plurality of image sensors 220 on or off as may be required. In some embodiments, monitoring an object or person captured by an image sensor 220 may include tracking movement of the object across the fields of view of the plurality of image sensors 220.

Embodiments consistent with the present disclosure may include connectors configured to connect a capturing unit and a power unit of a wearable apparatus. Capturing units consistent with the present disclosure may include least one image sensor configured to capture images of an environment of a user. Power units consistent with the present disclosure may be configured to house a power source and/or at least one processing device. Connectors consistent with the present disclosure may be configured to connect the capturing unit and the power unit, and may be configured to secure the apparatus to an article of clothing such that the capturing unit is positioned over an outer surface of the article of clothing and the power unit is positioned under an inner surface of the article of clothing.

Camera-Based Directional Hearing Aid

As discussed previously, the disclosed embodiments may include providing feedback, such as acoustical and tactile feedback, to one or more auxiliary devices in response to processing at least one image in an environment. In some embodiments, the auxiliary device may be an earpiece or other device used to provide auditory feedback to the user, such as a hearing aid. Traditional hearing aids often use microphones to amplify sounds in the user's environment. These traditional systems, however, are often unable to distinguish between sounds that may be of particular importance to the wearer of the device, or may do so on a limited basis. Using the systems and methods of the disclosed embodiments, various improvements to traditional hearing aids are provided, as described in detail below.

In one embodiment, a camera-based directional hearing aid may be provided for selectively amplifying sounds based on a look direction of a user. The hearing aid may communicate with an image capturing device, such as apparatus 110, to determine the look direction of the user. This look direction may be used to isolate and/or selectively amplify sounds received from that direction (e.g., sounds from individuals in the user's look direction, etc.). Sounds received from directions other than the user's look direction may be suppressed, attenuated, filtered or the like.

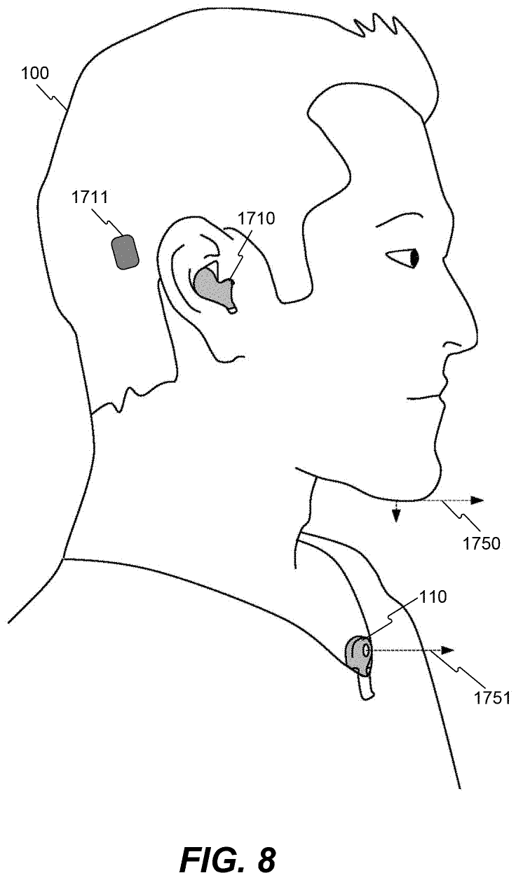

FIG. 8 is a schematic illustration of an example of a user 100 wearing an apparatus 110 for a camera-based hearing interface device 1710 according to a disclosed embodiment. User 100 may wear apparatus 110 that is physically connected to a shirt or other piece of clothing of user 100, as shown. Consistent with the disclosed embodiments, apparatus 110 may be positioned in other locations, as described previously. For example, apparatus 110 may be physically connected to a necklace, a belt, glasses, a wrist strap, a button, etc. Apparatus 110 may be configured to communicate with a hearing interface device such as hearing interface device 1710. Such communication may be through a wired connection, or may be made wirelessly (e.g., using a Bluetooth™, NFC, or forms of wireless communication). In some embodiments, one or more additional devices may also be included, such as computing device 120. Accordingly, one or more of the processes or functions described herein with respect to apparatus 110 or processor 210 may be performed by computing device 120 and/or processor 540.

Hearing interface device 1710 may be any device configured to provide audible feedback to user 100. Hearing interface device 1710 may correspond to feedback outputting unit 230, described above, and therefore any descriptions of feedback outputting unit 230 may also apply to hearing interface device 1710. In some embodiments, hearing interface device 1710 may be separate from feedback outputting unit 230 and may be configured to receive signals from feedback outputting unit 230. As shown in FIG. 8, hearing interface device 1710 may be placed in one or both ears of user 100, similar to traditional hearing interface devices. Hearing interface device 1710 may be of various styles, including in-the-canal, completely-in-canal, in-the-ear, behind-the-ear, on-the-ear, receiver-in-canal, open fit, or various other styles. Hearing interface device 1710 may include one or more speakers for providing audible feedback to user 100, microphones for detecting sounds in the environment of user 100, internal electronics, processors, memories, etc. In some embodiments, in addition to or instead of a microphone, hearing interface device 1710 may comprise one or more communication units, and in particular one or more receivers for receiving signals from apparatus 110 and transferring the signals to user 100.

Hearing interface device 1710 may have various other configurations or placement locations. In some embodiments, hearing interface device 1710 may comprise a bone conduction headphone 1711, as shown in FIG. 8. Bone conduction headphone 1711 may be surgically implanted and may provide audible feedback to user 100 through bone conduction of sound vibrations to the inner ear. Hearing interface device 1710 may also comprise one or more headphones (e.g., wireless headphones, over-ear headphones, etc.) or a portable speaker carried or worn by user 100. In some embodiments, hearing interface device 1710 may be integrated into other devices, such as a Bluetooth™ headset of the user, glasses, a helmet (e.g., motorcycle helmets, bicycle helmets, etc.), a hat, etc.

Apparatus 110 may be configured to determine a user look direction 1750 of user 100. In some embodiments, user look direction 1750 may be tracked by monitoring a direction of the chin, or another body part or face part of user 100 relative to an optical axis of a camera sensor 1751. Apparatus 110 may be configured to capture one or more images of the surrounding environment of user, for example, using image sensor 220. The captured images may include a representation of a chin of user 100, which may be used to determine user look direction 1750. Processor 210 (and/or processors 210a and 210b) may be configured to analyze the captured images and detect the chin or another part of user 100 using various image detection or processing algorithms (e.g., using convolutional neural networks (CNN), scale-invariant feature transform (SIFT), histogram of oriented gradients (HOG) features, or other techniques). Based on the detected representation of a chin of user 100, look direction 1750 may be determined. Look direction 1750 may be determined in part by comparing the detected representation of a chin of user 100 to an optical axis of a camera sensor 1751. For example, the optical axis 1751 may be known or fixed in each image and processor 210 may determine look direction 1750 by comparing a representative angle of the chin of user 100 to the direction of optical axis 1751. While the process is described using a representation of a chin of user 100, various other features may be detected for determining user look direction 1750, including the user's face, nose, eyes, hand, etc.

In other embodiments, user look direction 1750 may be aligned more closely with the optical axis 1751. For example, as discussed above, apparatus 110 may be affixed to a pair of glasses of user 100, as shown in FIG. 1A. In this embodiment, user look direction 1750 may be the same as or close to the direction of optical axis 1751. Accordingly, user look direction 1750 may be determined or approximated based on the view of image sensor 220.

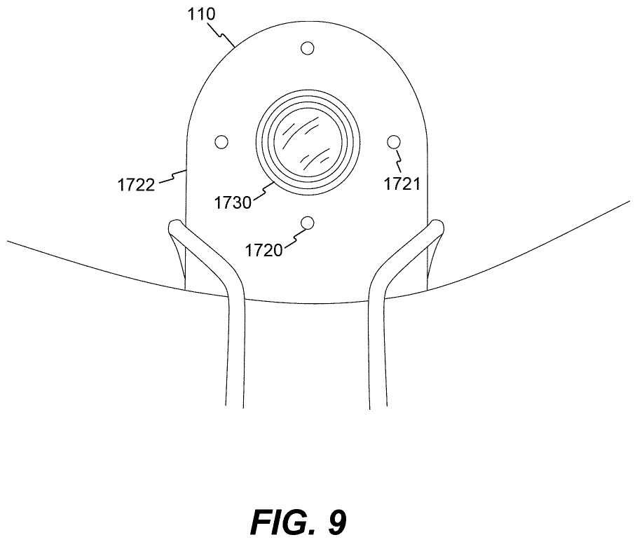

FIG. 9 is a schematic illustration of an embodiment of an apparatus securable to an article of clothing consistent with the present disclosure. Apparatus 110 may be securable to a piece of clothing, such as the shirt of user 110, as shown in FIG. 8. Apparatus 110 may be securable to other articles of clothing, such as a belt or pants of user 100, as discussed above. Apparatus 110 may have one or more cameras 1730, which may correspond to image sensor 220. Camera 1730 may be configured to capture images of the surrounding environment of user 100. In some embodiments, camera 1730 may be configured to detect a representation of a chin of the user in the same images capturing the surrounding environment of the user, which may be used for other functions described in this disclosure. In other embodiments camera 1730 may be an auxiliary or separate camera dedicated to determining user look direction 1750.

Apparatus 110 may further comprise one or more microphones 1720 for capturing sounds from the environment of user 100. Microphone 1720 may also be configured to determine a directionality of sounds in the environment of user 100. For example, microphone 1720 may comprise one or more directional microphones, which may be more sensitive to picking up sounds in certain directions. For example, microphone 1720 may comprise a unidirectional microphone, designed to pick up sound from a single direction or small range of directions. Microphone 1720 may also comprise a cardioid microphone, which may be sensitive to sounds from the front and sides. Microphone 1720 may also include a microphone array, which may comprise additional microphones, such as microphone 1721 on the front of apparatus 110, or microphone 1722, placed on the side of apparatus 110. In some embodiments, microphone 1720 may be a multi-port microphone for capturing multiple audio signals. The microphones shown in FIG. 9 are by way of example only, and any suitable number, configuration, or location of microphones may be utilized. Processor 210 may be configured to distinguish sounds within the environment of user 100 and determine an approximate directionality of each sound. For example, using an array of microphones 1720, processor 210 may compare the relative timing or amplitude of an individual sound among the microphones 1720 to determine a directionality relative to apparatus 100.

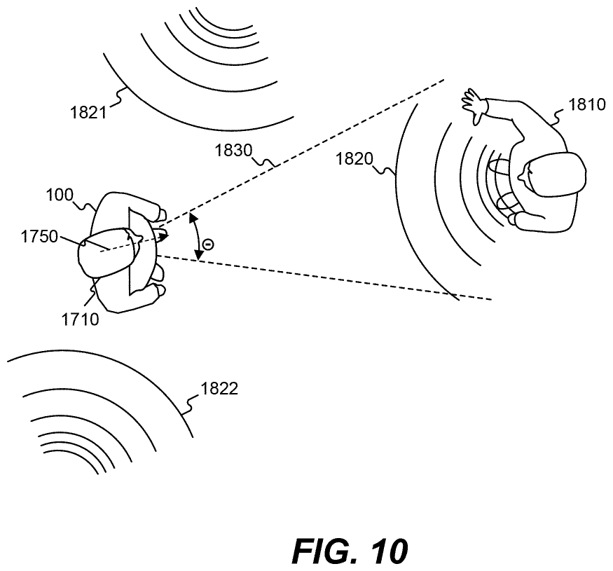

Based on the determined user look direction 1750, processor 210 may selectively condition or amplify sounds from a region associated with user look direction 1750. FIG. 10 is a schematic illustration showing an exemplary environment for use of a camera-based hearing aid consistent with the present disclosure. Microphone 1720 may detect one or more sounds 1820, 1821, and 1822 within the environment of user 100. Based on user look direction 1750, determined by processor 210, a region 1830 associated with user look direction 1750 may be determined. As shown in FIG. 10, region 1830 may be defined by a cone or range of directions based on user look direction 1750. The range of angles may be defined by an angle, θ, as shown in FIG. 10. The angle, θ, may be any suitable angle for defining a range for conditioning sounds within the environment of user 100 (e.g., 10 degrees, 20 degrees, 45 degrees).

Processor 210 may be configured to cause selective conditioning of sounds in the environment of user 100 based on region 1830. The conditioned audio signal may be transmitted to hearing interface device 1710, and thus may provide user 100 with audible feedback corresponding to the look direction of the user. For example, processor 210 may determine that sound 1820 (which may correspond to the voice of an individual 1810, or to noise for example) is within region 1830. Processor 210 may then perform various conditioning techniques on the audio signals received from microphone 1720. The conditioning may include amplifying audio signals determined to correspond to sound 1820 relative to other audio signals. Amplification may be accomplished digitally, for example by processing audio signals associated with 1820 relative to other signals. Amplification may also be accomplished by changing one or more parameters of microphone 1720 to focus on audio sounds emanating from region 1830 (e.g., a region of interest) associated with user look direction 1750. For example, microphone 1720 may be a directional microphone that and processor 210 may perform an operation to focus microphone 1720 on sound 1820 or other sounds within region 1830. Various other techniques for amplifying sound 1820 may be used, such as using a beamforming microphone array, acoustic telescope techniques, etc.

Conditioning may also include attenuation or suppressing one or more audio signals received from directions outside of region 1830. For example, processor 1820 may attenuate sounds 1821 and 1822. Similar to amplification of sound 1820, attenuation of sounds may occur through processing audio signals, or by varying one or more parameters associated with one or more microphones 1720 to direct focus away from sounds emanating from outside of region 1830.

In some embodiments, conditioning may further include changing a tone of audio signals corresponding to sound 1820 to make sound 1820 more perceptible to user 100. For example, user 100 may have lesser sensitivity to tones in a certain range and conditioning of the audio signals may adjust the pitch of sound 1820 to make it more perceptible to user 100. For example, user 100 may experience hearing loss in frequencies above 10 kHz. Accordingly, processor 210 may remap higher frequencies (e.g., at 15 kHz) to 10 kHz. In some embodiments processor 210 may be configured to change a rate of speech associated with one or more audio signals. Accordingly, processor 210 may be configured to detect speech within one or more audio signals received by microphone 1720, for example using voice activity detection (VAD) algorithms or techniques. If sound 1820 is determined to correspond to voice or speech, for example from individual 1810, processor 220 may be configured to vary the playback rate of sound 1820. For example, the rate of speech of individual 1810 may be decreased to make the detected speech more perceptible to user 100. Various other processing may be performed, such as modifying the tone of sound 1820 to maintain the same pitch as the original audio signal, or to reduce noise within the audio signal. If speech recognition has been performed on the audio signal associated with sound 1820, conditioning may further include modifying the audio signal based on the detected speech. For example, processor 210 may introduce pauses or increase the duration of pauses between words and/or sentences, which may make the speech easier to understand.

The conditioned audio signal may then be transmitted to hearing interface device 1710 and produced for user 100. Thus, in the conditioned audio signal, sound 1820 may be easier to hear to user 100, louder and/or more easily distinguishable than sounds 1821 and 1822, which may represent background noise within the environment.

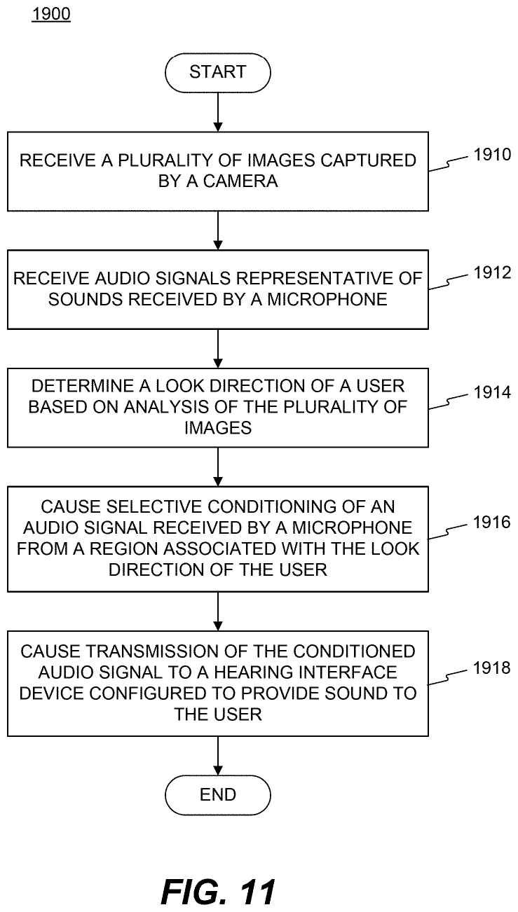

FIG. 11 is a flowchart showing an exemplary process 1900 for selectively amplifying sounds emanating from a detected look direction of a user consistent with disclosed embodiments. Process 1900 may be performed by one or more processors associated with apparatus 110, such as processor 210. In some embodiments, some or all of process 1900 may be performed on processors external to apparatus 110. In other words, the processor performing process 1900 may be included in a common housing as microphone 1720 and camera 1730, or may be included in a second housing. For example, one or more portions of process 1900 may be performed by processors in hearing interface device 1710, or an auxiliary device, such as computing device 120.

In step 1910, process 1900 may include receiving a plurality of images from an environment of a user captured by a camera. The camera may be a wearable camera such as camera 1730 of apparatus 110. In step 1912, process 1900 may include receiving audio signals representative of sounds received by at least one microphone. The microphone may be configured to capture sounds from an environment of the user. For example, the microphone may be microphone 1720, as described above. Accordingly, the microphone may include a directional microphone, a microphone array, a multi-port microphone, or various other types of microphones. In some embodiments, the microphone and wearable camera may be included in a common housing, such as the housing of apparatus 110. The one or more processors performing process 1900 may also be included in the housing or may be included in a second housing. In such embodiments, the processor(s) may be configured to receive images and/or audio signals from the common housing via a wireless link (e.g., Bluetooth™, NFC, etc.). Accordingly, the common housing (e.g., apparatus 110) and the second housing (e.g., computing device 120) may further comprise transmitters or various other communication components.

In step 1914, process 1900 may include determining a look direction for the user based on analysis of at least one of the plurality of images. As discussed above, various techniques may be used to determine the user look direction. In some embodiments, the look direction may be determined based, at least in part, upon detection of a representation of a chin of a user in one or more images. The images may be processed to determine a pointing direction of the chin relative to an optical axis of the wearable camera, as discussed above.

In step 1916, process 1900 may include causing selective conditioning of at least one audio signal received by the at least one microphone from a region associated with the look direction of the user. As described above, the region may be determined based on the user look direction determined in step 1914. The range may be associated with an angular width about the look direction (e.g., 10 degrees, 20 degrees, 45 degrees, etc.). Various forms of conditioning may be performed on the audio signal, as discussed above. In some embodiments, conditioning may include changing the tone or playback speed of an audio signal. For example, conditioning may include changing a rate of speech associated with the audio signal. In some embodiments, the conditioning may include amplification of the audio signal relative to other audio signals received from outside of the region associated with the look direction of the user. Amplification may be performed by various means, such as operation of a directional microphone configured to focus on audio sounds emanating from the region, or varying one or more parameters associated with the microphone to cause the microphone to focus on audio sounds emanating from the region. The amplification may include attenuating or suppressing one or more audio signals received by the microphone from directions outside the region associated with the look direction of user 110.

In step 1918, process 1900 may include causing transmission of the at least one conditioned audio signal to a hearing interface device configured to provide sound to an ear of the user. The conditioned audio signal, for example, may be transmitted to hearing interface device 1710, which may provide sound corresponding to the audio signal to user 100. The processor performing process 1900 may further be configured to cause transmission to the hearing interface device of one or more audio signals representative of background noise, which may be attenuated relative to the at least one conditioned audio signal. For example, processor 220 may be configured to transmit audio signals corresponding to sounds 1820, 1821, and 1822. The signal associated with 1820, however, may be modified in a different manner, for example amplified, from sounds 1821 and 1822 based on a determination that sound 1820 is within region 1830. In some embodiments, hearing interface device 1710 may include a speaker associated with an earpiece. For example, hearing interface device may be inserted at least partially into the ear of the user for providing audio to the user. Hearing interface device may also be external to the ear, such as a behind-the-ear hearing device, one or more headphones, a small portable speaker, or the like. In some embodiments, hearing interface device may include a bone conduction microphone, configured to provide an audio signal to user through vibrations of a bone of the user's head. Such devices may be placed in contact with the exterior of the user's skin, or may be implanted surgically and attached to the bone of the user.

Hearing Aid with Voice and/or Image Recognition

Consistent with the disclosed embodiments, a hearing aid may selectively amplify audio signals associated with a voice of a recognized individual. The hearing aid system may store voice characteristics and/or facial features of a recognized person to aid in recognition and selective amplification. For example, when an individual enters the field of view of apparatus 110, the individual may be recognized as an individual that has been introduced to the device, or that has possibly interacted with user 100 in the past (e.g., a friend, colleague, relative, prior acquaintance, etc.). Accordingly, audio signals associated with the recognized individual's voice may be isolated and/or selectively amplified relative to other sounds in the environment of the user. Audio signals associated with sounds received from directions other than the individual's direction may be suppressed, attenuated, filtered or the like.

User 100 may wear a hearing aid device similar to the camera-based hearing aid device discussed above. For example, the hearing aid device may be hearing interface device 1720, as shown in FIG. 8. Hearing interface device 1710 may be any device configured to provide audible feedback to user 100. Hearing interface device 1710 may be placed in one or both ears of user 100, similar to traditional hearing interface devices. As discussed above, hearing interface device 1710 may be of various styles, including in-the-canal, completely-in-canal, in-the-ear, behind-the-ear, on-the-ear, receiver-in-canal, open fit, or various other styles. Hearing interface device 1710 may include one or more speakers for providing audible feedback to user 100, a communication unit for receiving signals from another system, such as apparatus 110, microphones for detecting sounds in the environment of user 100, internal electronics, processors, memories, etc. Hearing interface device 1710 may correspond to feedback outputting unit 230 or may be separate from feedback outputting unit 230 and may be configured to receive signals from feedback outputting unit 230.

In some embodiments, hearing interface device 1710 may comprise a bone conduction headphone 1711, as shown in FIG. 8. Bone conduction headphone 1711 may be surgically implanted and may provide audible feedback to user 100 through bone conduction of sound vibrations to the inner ear. Hearing interface device 1710 may also comprise one or more headphones (e.g., wireless headphones, over-ear headphones, etc.) or a portable speaker carried or worn by user 100. In some embodiments, hearing interface device 1710 may be integrated into other devices, such as a Bluetooth™ headset of the user, glasses, a helmet (e.g., motorcycle helmets, bicycle helmets, etc.), a hat, etc.

Hearing interface device 1710 may be configured to communicate with a camera device, such as apparatus 110. Such communication may be through a wired connection, or may be made wirelessly (e.g., using a Bluetooth™, NFC, or forms of wireless communication). As discussed above, apparatus 110 may be worn by user 100 in various configurations, including being physically connected to a shirt, necklace, a belt, glasses, a wrist strap, a button, or other articles associated with user 100. In some embodiments, one or more additional devices may also be included, such as computing device 120. Accordingly, one or more of the processes or functions described herein with respect to apparatus 110 or processor 210 may be performed by computing device 120 and/or processor 540.

As discussed above, apparatus 110 may comprise at least one microphone and at least one image capture device. Apparatus 110 may comprise microphone 1720, as described with respect to FIG. 9. Microphone 1720 may be configured to determine a directionality of sounds in the environment of user 100. For example, microphone 1720 may comprise one or more directional microphones, a microphone array, a multi-port microphone, or the like. The microphones shown in FIG. 9 are by way of example only, and any suitable number, configuration, or location of microphones may be utilized. Processor 210 may be configured to distinguish sounds within the environment of user 100 and determine an approximate directionality of each sound. For example, using an array of microphones 1720, processor 210 may compare the relative timing or amplitude of an individual sound among the microphones 1720 to determine a directionality relative to apparatus 100. Apparatus 110 may comprise one or more cameras, such as camera 1730, which may correspond to image sensor 220. Camera 1730 may be configured to capture images of the surrounding environment of user 100.

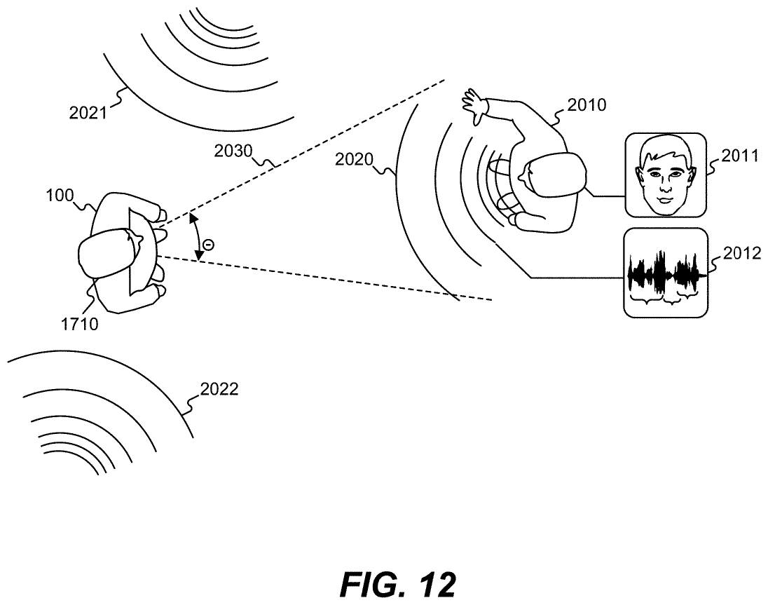

Apparatus 110 may be configured to recognize an individual in the environment of user 100. FIG. 12 is a schematic illustration showing an exemplary environment for use of a hearing aid with voice and/or image recognition consistent with the present disclosure. Apparatus 110 may be configured to recognize a face 2011 or voice 2012 associated with an individual 2010 within the environment of user 100. For example, apparatus 110 may be configured to capture one or more images of the surrounding environment of user 100 using camera 1730. The captured images may include a representation of a recognized individual 2010, which may be a friend, colleague, relative, or prior acquaintance of user 100. Processor 210 (and/or processors 210a and 210b) may be configured to analyze the captured images and detect the recognized user using various facial recognition techniques, as represented by element 2011. Accordingly, apparatus 110, or specifically memory 550, may comprise one or more facial or voice recognition components.

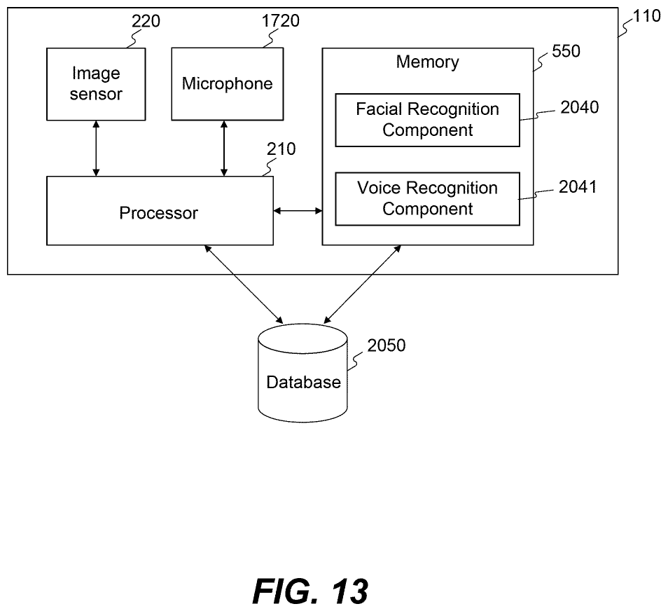

FIG. 13 illustrates an exemplary embodiment of apparatus 110 comprising facial and voice recognition components consistent with the present disclosure. Apparatus 110 is shown in FIG. 13 in a simplified form, and apparatus 110 may contain additional elements or may have alternative configurations, for example, as shown in FIGS. 5A-5C. Memory 550 (or 550a or 550b) may include facial recognition component 2040 and voice recognition component 2041. These components may be instead of or in addition to orientation identification module 601, orientation adjustment module 602, and motion tracking module 603 as shown in FIG. 6. Components 2040 and 2041 may contain software instructions for execution by at least one processing device, e.g., processor 210, included with a wearable apparatus. Components 2040 and 2041 are shown within memory 550 by way of example only, and may be located in other locations within the system. For example, components 2040 and 2041 may be located in hearing interface device 1710, in computing device 120, on a remote server, or in another associated device.

Facial recognition component 2040 may be configured to identify one or more faces within the environment of user 100. For example, facial recognition component 2040 may identify facial features on the face 2011 of individual 2010, such as the eyes, nose, cheekbones, jaw, or other features. Facial recognition component 2040 may then analyze the relative size and position of these features to identify the user. Facial recognition component 2040 may utilize one or more algorithms for analyzing the detected features, such as principal component analysis (e.g., using eigenfaces), linear discriminant analysis, elastic bunch graph matching (e.g., using Fisherface), Local Binary Patterns Histograms (LBPH), Scale Invariant Feature Transform (SIFT), Speed Up Robust Features (SURF), or the like. Other facial recognition techniques such as 3-Dimensional recognition, skin texture analysis, and/or thermal imaging may also be used to identify individuals. Other features besides facial features may also be used for identification, such as the height, body shape, or other distinguishing features of individual 2010.

Facial recognition component 2040 may access a database or data associated with user 100 to determine if the detected facial features correspond to a recognized individual. For example, a processor 210 may access a database 2050 containing information about individuals known to user 100 and data representing associated facial features or other identifying features. Such data may include one or more images of the individuals, or data representative of a face of the user that may be used for identification through facial recognition. Database 2050 may be any device capable of storing information about one or more individuals, and may include a hard drive, a solid state drive, a web storage platform, a remote server, or the like. Database 2050 may be located within apparatus 110 (e.g., within memory 550) or external to apparatus 110, as shown in FIG. 13. In some embodiments, database 2050 may be associated with a social network platform, such as Facebook™, LinkedIn™, Instagram™, etc. Facial recognition component 2040 may also access a contact list of user 100, such as a contact list on the user's phone, a web-based contact list (e.g., through Outlook™, Skype™, Google™, SalesForce™, etc.) or a dedicated contact list associated with hearing interface device 1710. In some embodiments, database 2050 may be compiled by apparatus 110 through previous facial recognition analysis. For example, processor 210 may be configured to store data associated with one or more faces recognized in images captured by apparatus 110 in database 2050. Each time a face is detected in the images, the detected facial features or other data may be compared to previously identified faces in database 2050. Facial recognition component 2040 may determine that an individual is a recognized individual of user 100 if the individual has previously been recognized by the system in a number of instances exceeding a certain threshold, if the individual has been explicitly introduced to apparatus 110, or the like.

In some embodiments, user 100 may have access to database 2050, such as through a web interface, an application on a mobile device, or through apparatus 110 or an associated device. For example, user 100 may be able to select which contacts are recognizable by apparatus 110 and/or delete or add certain contacts manually. In some embodiments, a user or administrator may be able to train facial recognition component 2040. For example, user 100 may have an option to confirm or reject identifications made by facial recognition component 2040, which may improve the accuracy of the system. This training may occur in real time, as individual 2010 is being recognized, or at some later time.

Other data or information may also inform the facial identification process. In some embodiments, processor 210 may use various techniques to recognize the voice of individual 2010, as described in further detail below. The recognized voice pattern and the detected facial features may be used, either alone or in combination, to determine that individual 2010 is recognized by apparatus 110. Processor 210 may also determine a user look direction 1750, as described above, which may be used to verify the identity of individual 2010. For example, if user 100 is looking in the direction of individual 2010 (especially for a prolonged period), this may indicate that individual 2010 is recognized by user 100, which may be used to increase the confidence of facial recognition component 2040 or other identification means.

Processor 210 may further be configured to determine whether individual 2010 is recognized by user 100 based on one or more detected audio characteristics of sounds associated with a voice of individual 2010. Returning to FIG. 12, processor 210 may determine that sound 2020 corresponds to voice 2012 of user 2010. Processor 210 may analyze audio signals representative of sound 2020 captured by microphone 1720 to determine whether individual 2010 is recognized by user 100. This may be performed using voice recognition component 2041 (FIG. 13) and may include one or more voice recognition algorithms, such as Hidden Markov Models, Dynamic Time Warping, neural networks, or other techniques. Voice recognition component and/or processor 210 may access database 2050, which may further include a voiceprint of one or more individuals. Voice recognition component 2041 may analyze the audio signal representative of sound 2020 to determine whether voice 2012 matches a voiceprint of an individual in database 2050. Accordingly, database 2050 may contain voiceprint data associated with a number of individuals, similar to the stored facial identification data described above. After determining a match, individual 2010 may be determined to be a recognized individual of user 100. This process may be used alone, or in conjunction with the facial recognition techniques described above. For example, individual 2010 may be recognized using facial recognition component 2040 and may be verified using voice recognition component 2041, or vice versa.

In some embodiments, apparatus 110 may detect the voice of an individual that is not within the field of view of apparatus 110. For example, the voice may be heard over a speakerphone, from a back seat, or the like. In such embodiments, recognition of an individual may be based on the voice of the individual only, in the absence of a speaker in the field of view. Processor 110 may analyze the voice of the individual as described above, for example, by determining whether the detected voice matches a voiceprint of an individual in database 2050.

After determining that individual 2010 is a recognized individual of user 100, processor 210 may cause selective conditioning of audio associated with the recognized individual. The conditioned audio signal may be transmitted to hearing interface device 1710, and thus may provide user 100 with audio conditioned based on the recognized individual. For example, the conditioning may include amplifying audio signals determined to correspond to sound 2020 (which may correspond to voice 2012 of individual 2010) relative to other audio signals. In some embodiments, amplification may be accomplished digitally, for example by processing audio signals associated with sound 2020 relative to other signals. Additionally, or alternatively, amplification may be accomplished by changing one or more parameters of microphone 1720 to focus on audio sounds associated with individual 2010. For example, microphone 1720 may be a directional microphone and processor 210 may perform an operation to focus microphone 1720 on sound 2020. Various other techniques for amplifying sound 2020 may be used, such as using a beamforming microphone array, acoustic telescope techniques, etc.

In some embodiments, selective conditioning may include attenuation or suppressing one or more audio signals received from directions not associated with individual 2010. For example, processor 210 may attenuate sounds 2021 and/or 2022. Similar to amplification of sound 2020, attenuation of sounds may occur through processing audio signals, or by varying one or more parameters associated with microphone 1720 to direct focus away from sounds not associated with individual 2010.

Selective conditioning may further include determining whether individual 2010 is speaking. For example, processor 210 may be configured to analyze images or videos containing representations of individual 2010 to determine when individual 2010 is speaking, for example, based on detected movement of the recognized individual's lips. This may also be determined through analysis of audio signals received by microphone 1720, for example by detecting the voice 2012 of individual 2010. In some embodiments, the selective conditioning may occur dynamically (initiated and/or terminated) based on whether or not the recognized individual is speaking.

In some embodiments, conditioning may further include changing a tone of one or more audio signals corresponding to sound 2020 to make the sound more perceptible to user 100. For example, user 100 may have lesser sensitivity to tones in a certain range and conditioning of the audio signals may adjust the pitch of sound 2020. In some embodiments processor 210 may be configured to change a rate of speech associated with one or more audio signals. For example, sound 2020 may be determined to correspond to voice 2012 of individual 2010. Processor 210 may be configured to vary the rate of speech of individual 2010 to make the detected speech more perceptible to user 100. Various other processing may be performed, such as modifying the tone of sound 2020 to maintain the same pitch as the original audio signal, or to reduce noise within the audio signal.

In some embodiments, processor 210 may determine a region 2030 associated with individual 2010. Region 2030 may be associated with a direction of individual 2010 relative to apparatus 110 or user 100. The direction of individual 2010 may be determined using camera 1730 and/or microphone 1720 using the methods described above. As shown in FIG. 12, region 2030 may be defined by a cone or range of directions based on a determined direction of individual 2010. The range of angles may be defined by an angle, θ, as shown in FIG. 12. The angle, θ, may be any suitable angle for defining a range for conditioning sounds within the environment of user 100 (e.g., 10 degrees, 20 degrees, 45 degrees). Region 2030 may be dynamically calculated as the position of individual 2010 changes relative to apparatus 110. For example, as user 100 turns, or if individual 1020 moves within the environment, processor 210 may be configured to track individual 2010 within the environment and dynamically update region 2030. Region 2030 may be used for selective conditioning, for example by amplifying sounds associated with region 2030 and/or attenuating sounds determined to be emanating from outside of region 2030.

The conditioned audio signal may then be transmitted to hearing interface device 1710 and produced for user 100. Thus, in the conditioned audio signal, sound 2020 (and specifically voice 2012) may be louder and/or more easily distinguishable than sounds 2021 and 2022, which may represent background noise within the environment.

In some embodiments, processor 210 may perform further analysis based on captured images or videos to determine how to selectively condition audio signals associated with a recognized individual. In some embodiments, processor 210 may analyze the captured images to selectively condition audio associated with one individual relative to others. For example, processor 210 may determine the direction of a recognized individual relative to the user based on the images and may determine how to selectively condition audio signals associated with the individual based on the direction. If the recognized individual is standing to the front of the user, audio associated with that user may be amplified (or otherwise selectively conditioned) relative to audio associated with an individual standing to the side of the user. Similarly, processor 210 may selectively condition audio signals associated with an individual based on proximity to the user. Processor 210 may determine a distance from the user to each individual based on captured images and may selectively condition audio signals associated with the individuals based on the distance. For example, an individual closer to the user may be prioritized higher than an individual that is farther away.

In some embodiments, selective conditioning of audio signals associated with a recognized individual may be based on the identities of individuals within the environment of the user. For example, where multiple individuals are detected in the images, processor 210 may use one or more facial recognition techniques to identify the individuals, as described above. Audio signals associated with individuals that are known to user 100 may be selectively amplified or otherwise conditioned to have priority over unknown individuals. For example, processor 210 may be configured to attenuate or silence audio signals associated with bystanders in the user's environment, such as a noisy office mate, etc. In some embodiments, processor 210 may also determine a hierarchy of individuals and give priority based on the relative status of the individuals. This hierarchy may be based on the individual's position within a family or an organization (e.g., a company, sports team, club, etc.) relative to the user. For example, the user's boss may be ranked higher than a co-worker or a member of the maintenance staff and thus may have priority in the selective conditioning process. In some embodiments, the hierarchy may be determined based on a list or database. Individuals recognized by the system may be ranked individually or grouped into tiers of priority. This database may be maintained specifically for this purpose, or may be accessed externally. For example, the database may be associated with a social network of the user (e.g., Facebook™, LinkedIn™, etc.) and individuals may be prioritized based on their grouping or relationship with the user. Individuals identified as “close friends” or family, for example, may be prioritized over acquaintances of the user.

Selective conditioning may be based on a determined behavior of one or more individuals determined based on the captured images. In some embodiments, processor 210 may be configured to determine a look direction of the individuals in the images. Accordingly, the selective conditioning may be based on behavior of the other individuals towards the recognized individual. For example, processor 210 may selectively condition audio associated with a first individual that one or more other users are looking at. If the attention of the individuals shifts to a second individual, processor 210 may then switch to selectively condition audio associated with the second user. In some embodiments, processor 210 may be configured to selectively condition audio based on whether a recognized individual is speaking to the user or to another individual. For example, when the recognized individual is speaking to the user, the selective conditioning may include amplifying an audio signal associated with the recognized individual relative to other audio signals received from directions outside a region associated with the recognized individual. When the recognized individual is speaking to another individual, the selective conditioning may include attenuating the audio signal relative to other audio signals received from directions outside the region associated with the recognized individual.

In some embodiments, processor 210 may have access to one or more voiceprints of individuals, which may facilitate selective conditioning of voice 2012 of individual 2010 in relation to other sounds or voices. Having a speaker's voiceprint, and a high quality voiceprint in particular, may provide for fast and efficient speaker separation. A high quality voice print may be collected, for example, when the user speaks alone, preferably in a quiet environment. By having a voiceprint of one or more speakers, it is possible to separate an ongoing voice signal almost in real time, e.g., with a minimal delay, using a sliding time window. The delay may be, for example 10 ms, 20 ms, 30 ms, 50 ms, 100 ms, or the like. Different time windows may be selected, depending on the quality of the voice print, on the quality of the captured audio, the difference in characteristics between the speaker and other speaker(s), the available processing resources, the required separation quality, or the like. In some embodiments, a voice print may be extracted from a segment of a conversation in which an individual speaks alone, and then used for separating the individual's voice later in the conversation, whether the individual's is recognized or not.

Separating voices may be performed as follows: spectral features, also referred to as spectral attributes, spectral envelope, or spectrogram may be extracted from a clean audio of a single speaker and fed into a pre-trained first neural network, which generates or updates a signature of the speaker's voice based on the extracted features. The audio may be for example, of one second of clean voice. The output signature may be a vector representing the speaker's voice, such that the distance between the vector and another vector extracted from the voice of the same speaker is typically smaller than the distance between the vector and a vector extracted from the voice of another speaker. The speaker's model may be pre-generated from a captured audio. Alternatively, or additionally, the model may be generated after a segment of the audio in which only the speaker speaks, followed by another segment in which the speaker and another speaker (or background noise) is heard, and which it is required to separate.

Then, to separate the speaker's voice from additional speakers or background noise in a noisy audio, a second pre-trained neural network may receive the noisy audio and the speaker's signature, and output an audio (which may also be represented as attributes) of the voice of the speaker as extracted from the noisy audio, separated from the other speech or background noise. It will be appreciated that the same or additional neural networks may be used to separate the voices of multiple speakers. For example, if there are two possible speakers, two neural networks may be activated, each with models of the same noisy output and one of the two speakers. Alternatively, a neural network may receive voice signatures of two or more speakers, and output the voice of each of the speakers separately. Accordingly, the system may generate two or more different audio outputs, each comprising the speech of the respective speaker. In some embodiments, if separation is impossible, the input voice may only be cleaned from background noise.

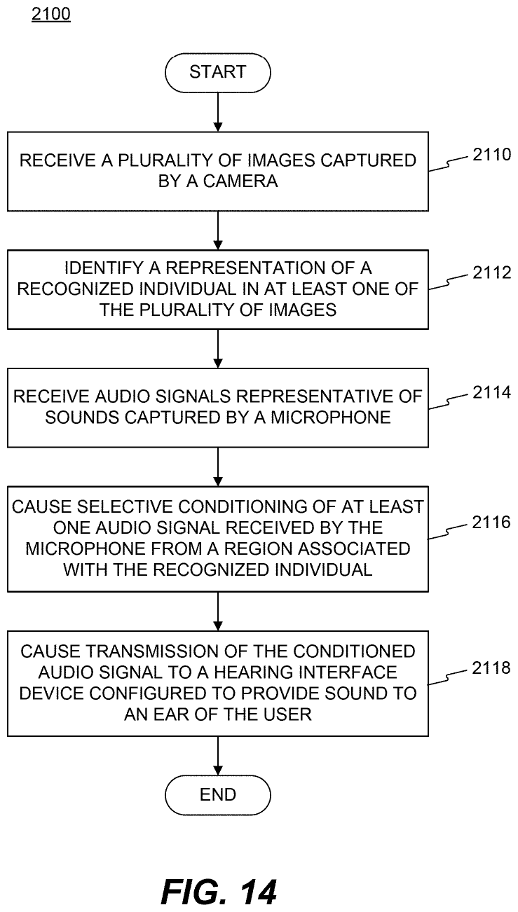

FIG. 14 is a flowchart showing an exemplary process 2100 for selectively amplifying audio signals associated with a voice of a recognized individual consistent with disclosed embodiments. Process 2100 may be performed by one or more processors associated with apparatus 110, such as processor 210. In some embodiments, some or all of process 2100 may be performed on processors external to apparatus 110. In other words, the processor performing process 2100 may be included in the same common housing as microphone 1720 and camera 1730, or may be included in a second housing. For example, one or more portions of process 2100 may be performed by processors in hearing interface device 1710, or in an auxiliary device, such as computing device 120.

In step 2110, process 2100 may include receiving a plurality of images from an environment of a user captured by a camera. The images may be captured by a wearable camera such as camera 1730 of apparatus 110. In step 2112, process 2100 may include identifying a representation of a recognized individual in at least one of the plurality of images. Individual 2010 may be recognized by processor 210 using facial recognition component 2040, as described above. For example, individual 2010 may be a friend, colleague, relative, or prior acquaintance of the user. Processor 210 may determine whether an individual represented in at least one of the plurality of images is a recognized individual based on one or more detected facial features associated with the individual. Processor 210 may also determine whether the individual is recognized based on one or more detected audio characteristics of sounds determined to be associated with a voice of the individual, as described above.

In step 2114, process 2100 may include receiving audio signals representative of sounds captured by a microphone. For example, apparatus 110 may receive audio signals representative of sounds 2020, 2021, and 2022, captured by microphone 1720. Accordingly, the microphone may include a directional microphone, a microphone array, a multi-port microphone, or various other types of microphones, as described above. In some embodiments, the microphone and wearable camera may be included in a common housing, such as the housing of apparatus 110. The one or more processors performing process 2100 may also be included in the housing (e.g., processor 210), or may be included in a second housing. Where a second housing is used, the processor(s) may be configured to receive images and/or audio signals from the common housing via a wireless link (e.g., Bluetooth™, NFC, etc.). Accordingly, the common housing (e.g., apparatus 110) and the second housing (e.g., computing device 120) may further comprise transmitters, receivers, and/or various other communication components.

In step 2116, process 2100 may include cause selective conditioning of at least one audio signal received by the at least one microphone from a region associated with the at least one recognized individual. As described above, the region may be determined based on a determined direction of the recognized individual based one or more of the plurality of images or audio signals. The range may be associated with an angular width about the direction of the recognized individual (e.g., 10 degrees, 20 degrees, 45 degrees, etc.).

Various forms of conditioning may be performed on the audio signal, as discussed above. In some embodiments, conditioning may include changing the tone or playback speed of an audio signal. For example, conditioning may include changing a rate of speech associated with the audio signal. In some embodiments, the conditioning may include amplification of the audio signal relative to other audio signals received from outside of the region associated with the recognized individual. Amplification may be performed by various means, such as operation of a directional microphone configured to focus on audio sounds emanating from the region or varying one or more parameters associated with the microphone to cause the microphone to focus on audio sounds emanating from the region. The amplification may include attenuating or suppressing one or more audio signals received by the microphone from directions outside the region. In some embodiments, step 2116 may further comprise determining, based on analysis of the plurality of images, that the recognized individual is speaking and trigger the selective conditioning based on the determination that the recognized individual is speaking. For example, the determination that the recognized individual is speaking may be based on detected movement of the recognized individual's lips. In some embodiments, selective conditioning may be based on further analysis of the captured images as described above, for example, based on the direction or proximity of the recognized individual, the identity of the recognized individual, the behavior of other individuals, etc.

In step 2118, process 2100 may include causing transmission of the at least one conditioned audio signal to a hearing interface device configured to provide sound to an ear of the user. The conditioned audio signal, for example, may be transmitted to hearing interface device 1710, which may provide sound corresponding to the audio signal to user 100. The processor performing process 2100 may further be configured to cause transmission to the hearing interface device of one or more audio signals representative of background noise, which may be attenuated relative to the at least one conditioned audio signal. For example, processor 210 may be configured to transmit audio signals corresponding to sounds 2020, 2021, and 2022. The signal associated with 2020, however, may be amplified in relation to sounds 2021 and 2022 based on a determination that sound 2020 is within region 2030. In some embodiments, hearing interface device 1710 may include a speaker associated with an earpiece. For example, hearing interface device 1710 may be inserted at least partially into the ear of the user for providing audio to the user. Hearing interface device may also be external to the ear, such as a behind-the-ear hearing device, one or more headphones, a small portable speaker, or the like. In some embodiments, hearing interface device may include a bone conduction microphone, configured to provide an audio signal to user through vibrations of a bone of the user's head. Such devices may be placed in contact with the exterior of the user's skin, or may be implanted surgically and attached to the bone of the user.

In addition to recognizing voices of individuals speaking to user 100, the systems and methods described above may also be used to recognize the voice of user 100. For example, voice recognition unit 2041 may be configured to analyze audio signals representative of sounds collected from the user's environment to recognize the voice of user 100. Similar to the selective conditioning of the voice of recognized individuals, the voice of user 100 may be selectively conditioned. For example, sounds may be collected by microphone 1720, or by a microphone of another device, such as a mobile phone (or a device linked to a mobile phone). Audio signals corresponding to the voice of user 100 may be selectively transmitted to a remote device, for example, by amplifying the voice of user 100 and/or attenuating or eliminating altogether sounds other than the user's voice. Accordingly, a voiceprint of one or more users of apparatus 110 may be collected and/or stored to facilitate detection and/or isolation of the user's voice, as described in further detail above.

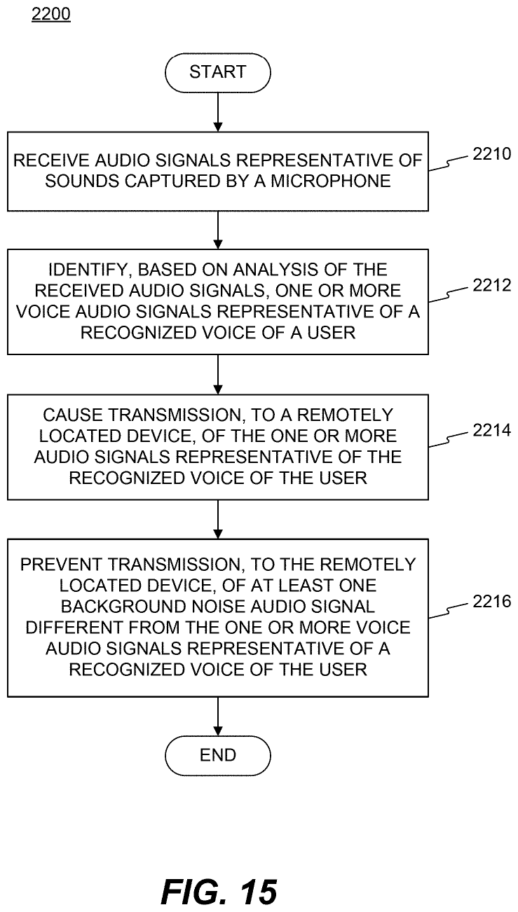

FIG. 15 is a flowchart showing an exemplary process 2200 for selectively transmitting audio signals associated with a voice of a recognized user consistent with disclosed embodiments. Process 2200 may be performed by one or more processors associated with apparatus 110, such as processor 210.

In step 2210, process 2200 may include receiving audio signals representative of sounds captured by a microphone. For example, apparatus 110 may receive audio signals representative of sounds 2020, 2021, and 2022, captured by microphone 1720. Accordingly, the microphone may include a directional microphone, a microphone array, a multi-port microphone, or various other types of microphones, as described above. In step 2212, process 2200 may include identifying, based on analysis of the received audio signals, one or more voice audio signals representative of a recognized voice of the user. For example, the voice of the user may be recognized based on a voiceprint associated with the user, which may be stored in memory 550, database 2050, or other suitable locations. Processor 210 may recognize the voice of the user, for example, using voice recognition component 2041. Processor 210 may separate an ongoing voice signal associated with the user almost in real time, e.g., with a minimal delay, using a sliding time window. The voice may be separated by extracting spectral features of an audio signal according to the methods described above.

In step 2214, process 2200 may include causing transmission, to a remotely located device, of the one or more voice audio signals representative of the recognized voice of the user. The remotely located device may be any device configured to receive audio signals remotely, either by a wired or wireless form of communication. In some embodiments, the remotely located device may be another device of the user, such as a mobile phone, an audio interface device, or another form of computing device. In some embodiments, the voice audio signals may be processed by the remotely located device and/or transmitted further. In step 2216, process 2200 may include preventing transmission, to the remotely located device, of at least one background noise audio signal different from the one or more voice audio signals representative of a recognized voice of the user. For example, processor 210 may attenuate and/or eliminate audio signals associated with sounds 2020, 2021, or 2023, which may represent background noise. The voice of the user may be separated from other noises using the audio processing techniques described above.

In an exemplary illustration, the voice audio signals may be captured by a headset or other device worn by the user. The voice of the user may be recognized and isolated from the background noise in the environment of the user. The headset may transmit the conditioned audio signal of the user's voice to a mobile phone of the user. For example, the user may be on a telephone call and the conditioned audio signal may be transmitted by the mobile phone to a recipient of the call. The voice of the user may also be recorded by the remotely located device. The audio signal, for example, may be stored on a remote server or other computing device. In some embodiments, the remotely located device may process the received audio signal, for example, to convert the recognized user's voice into text.

Processing Audio and Video Using a Voice Print

Multiple possibilities are enabled by apparatus 110 combining a sound capture device (e.g., a microphone) and an image capture device (image sensor). In some embodiments, apparatus 110 may enable processing of audio signals, for example transcription, word spotting, emotion extraction, sound separation, etc., captured during an interaction of a user of apparatus 110 with one or more other individuals. When processing captured audio, many algorithms for audio processing may perform better given a voice print or voice signature of a speaker. The performance of these algorithms may further increase with the preciseness or accuracy of the voice print. If the voice print of the speaker (which is used for processing the audio signal) is clean from background noise and other audio (e.g., speech of others, etc.), and truly represents the speaker's speech under those conditions (e.g., conditions that may affect the speaker's voice), then the quality of the audio signals processing results may be better. Thus, to process audio signals captured under certain conditions, a voice print that is based on the speaker's speech taken under the same or similar conditions may improve the quality of the resulting processed audio signals. These conditions may relate to the acoustic environment of the user (e.g., acoustics of the room or the location where the user is interacting with other individuals), specific characteristics of the speaker voice (e.g., one or more of pitch, tone, rate of speech, volume, rhythm, tempo, texture, resonance, center frequency, frequency distribution, etc.) which may change with the time of day and/or the speaker's condition (if the speaker has a cold, etc.), used equipment, or the like.

As explained previously (for example, with reference to FIGS. 5A-5C, 9, 13, etc.), apparatus 110 may include one or more microphones 1720 for capturing sounds from an environment of a user, and one or more cameras 1730 (which may correspond to image sensor 220) configured to capture images from the user's environment. Solely for ease of discussion, the single or multiple microphones of apparatus 100 will hereinafter be referred in the singular tense as a microphone, and the single or multiple images sensors of apparatus 110 will hereinafter be referred in the singular tense as an image sensor.

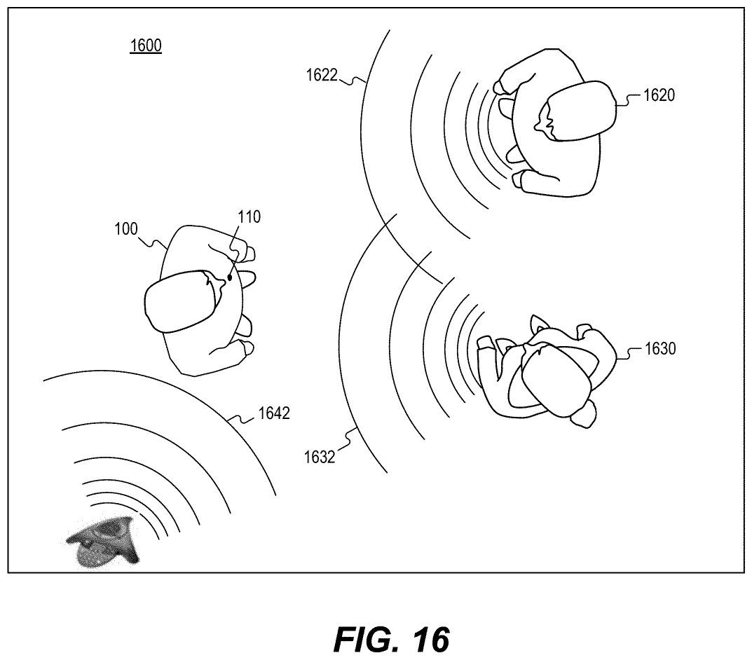

FIG. 16 is a schematic illustration of a user 100 wearing apparatus 110 and interacting with two individuals 1620, 1630 at a location 1600. Location 1600 may include any geographical region. In some embodiments, location 1600 may be defined as an area (or region) within a preselected radius (e.g., ⅛ mile, ¼ mile, ½ mile, 1 mile, 2 miles, etc.) around a defined point. For example, location 1600 may be defined as an area within a ½ mile of, for example, the intersection of Maple Avenue and 7^{th} Street in a city. In some embodiments, location 1600 may be defined as a street address, a building, a floor in a building, or a room within a building. In some embodiments, location 1600 may be a residence, a multi-story (e.g., 10 story) office building, a floor (e.g., 5^{th} floor) in the building, or a room (conference room, stairwell, office, etc.) in the building. In some embodiments, location 1600 may be defined as a region within a user-selected threshold distance. For example, the user may select a threshold distance within, for example, 1-600 meters (e.g., 500 meters, 250 meters, 100 meters, 50 meters, 10 meters, 5 meters, etc.), and location 1600 may then be defined as an area within a radius of the threshold distance. It is also contemplated that, in some embodiments, location 1600 may be defined as indoors (inside a building) or outdoors (outside a building). In different embodiments, the user may define the region covered by location 1600 based on the application.

When the user 100 is engaged with individuals 1620, 1630 at location 1600, the microphone of apparatus 110 may capture sounds from the environment of user 100 (i.e., location 1600). These sounds may include sounds 1622 made by individual 1620 and sounds 1632 made by individual 1630. These sounds 1622, 1632 may include all types of noises (voice, speech, coughing, etc.) made by the respective individuals 1620, 1630. The captured sounds may also include background sounds 1642 (e.g., telephone, music, A/C, passing vehicles, background noise, other people talking, etc.) at location 1600. Meanwhile, the image sensor of apparatus 110 may capture images from location 1600. One or more of these images may include a representation (e.g., a digital representation) of one or more of individuals 1620, 1630 that user 100 is interacting with. For example, when user 100 is looking at an individual who is speaking, one or more images captured by the image sensor may include an image of the speaker. One or more images captured by the image sensor may also include a representation of location 1600. For example, when location 1600 is a restaurant, one or more images captured by the image sensor may include a picture of the restaurant, or some identifier (restaurant name, dining tables, etc.) using which location 1600 may be identified. In some embodiments, a single image may include both the representation of an individual and a representation of the location. For example, an image may include a representation of an individual with the restaurant interior in the background. It should be noted that, in some embodiments, apparatus 110 may not include (or may not use) an image sensor.

One or more processors associated with apparatus 110 may receive and process the audio signals (and the images in some embodiments) captured by the microphone of apparatus 110. The processor may be a part of (e.g., in the same housing as) apparatus 110 (e.g., processor 220 of apparatus 110, see FIGS. 5A, 5C) or a part of another device associated with apparatus 110 (e.g., processor 540 of computing device 120, see FIG. 5C). A single processor or multiple processors (e.g., processors 210a and 210b of FIG. 5B, processors 210 and 540 of FIG. 5C, etc.) may receive and process the audio signals. In some embodiments, one portion of the processing may be performed by a first processor (e.g., processor 210) and another portion of the processing may be performed by a second processor (e.g., processor 540) operatively coupled with the first processor. Solely for ease of discussion, the one or more processors that receive and process the audio signals will be referred using the singular tense. However, it should be recognized that this processor may include a single processor or multiple processors (housed in a single housing or different housings) operatively coupled together. The processor may process the audio signals using or without using the images received from image sensor.

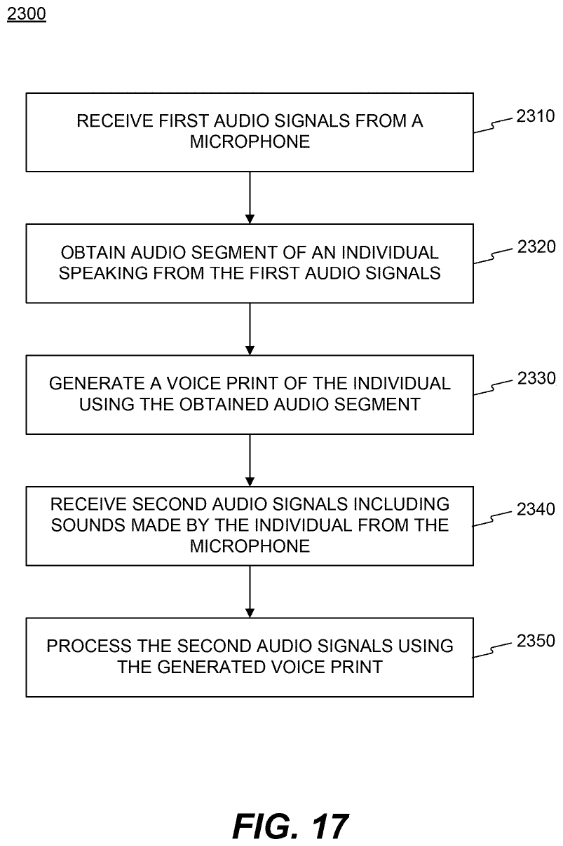

FIG. 17 is a flowchart showing an exemplary process 2300 for processing the audio signals received by processor. The processor may first receive the audio signals (first audio signals) from the microphone of apparatus 110 (step 2310). The received audio signals may correspond to the sounds captured by the microphone from location 1600 during a first time period when user 100 is interacting with individuals 1620, 1630 (see FIG. 16). The processor may then obtain an audio segment from the received audio signals (step 2320). The obtained audio segment in step 2320 may be a portion of the received audio signals that correspond to an individual's speech (for example, individual 1620). For example, the obtained audio signal may be a portion of the received audio signals having a predetermined length (e.g., 20 seconds, 10 seconds, 5 seconds, 3 seconds, 1 second, etc.) when only individual 1620 (or individual 1630) is speaking. The audio segment may be captured when there is no, or little background noise, such as A/C, passing vehicles, or the like. The audio segment may be obtained from the audio signals in any manner.

In some embodiments, audio processing algorithm(s) may be used to analyze the voice characteristics (e.g., spectral analysis of pitch, tone, frequency range, etc.) in the received audio signal and identify a portion where only individual 1620 is speaking and there is no or minimal background noise. As would be recognized by a person skilled in the art, algorithms may use audio closeness parameters (such as, for example, Itakura-Saito distance, frequency range, etc.) to determine the spectral similarity of voice in an audio signal. For example, a low value of the Itakura-Saito distance indicates that the voice in an audio segment is spectrally similar and therefore may belong to a single individual (e.g., individual 1620). Therefore, in some embodiments, a predetermined threshold value of the selected closeness parameter may be used for determining whether only one individual (e.g., individual 1620) is speaking in the audio segment.

In some embodiments, the audio segment obtained in step 2320 may also be selected such that the voice of individual 1620 in the audio segment is clear. As would be recognized by a person skilled in the art, algorithms use audio clearness parameters (such as, for example, clarity measurement index C₅₀, speech transmission index, etc.) to determine the clearness (or clarity) of speech in an audio signal. For example, a high value of clarity measurement index C₅₀, or a value of STI approaching one (1) may indicate that the voice in the audio segment is clear. Therefore, in some embodiments, a predetermined threshold value of the selected clearness parameter may be used for determining whether the voice in an audio segment is sufficiently clear.

It should be noted that the above-described audio parameters are only exemplary. In general, any attribute or characteristic of voice (e.g., pitch, tone, rate of speech, volume, rhythm, tempo, texture, resonance, center frequency, frequency distribution, responsiveness, etc.) may be used to select a portion of the audio signals where only a single individual (e.g., individual 1620) is speaking and that individual's voice is clear. For example, value(s) of one or more voice attributes satisfying (below, above, within a range, outside a range, etc.) a preselected threshold (frequency range within a threshold range, rate of speech below a threshold value, etc.) may be used to obtain an audio segment in step 2320. Thus, in some embodiments, the audio segment in step 2320 may be selected such that only a single individual is speaking and this individual's speech is clear.

In some embodiments, images received by processor 210 from the image sensor of apparatus 110 may be used to obtain the audio segment in step 2320. For example, based on the images received from the image sensor at any time, the processor may recognize that only one of the two individuals 1620, 1630 at location 1600 (FIG. 16) is speaking and may obtain a portion of the audio signals at that time as the audio segment. In some embodiments, the received images may be analyzed to determine that only a single individual is speaking (e.g., based on facial features, etc.) at a time, and a portion of the audio signals corresponding to that time may be selected as the audio segment. In some embodiments, both the received images and the audio signal may be analyzed to obtain the audio segment in step 2320. For example, the audio segment in step 2320 may be obtained when the images received by the processor (from the image sensor) indicate that only one individual is speaking and when a selected voice characteristic or attribute (e.g., pitch, tone, rate of speech, volume, rhythm, tempo, texture, resonance, center frequency, frequency distribution, responsiveness, etc.) satisfies a predetermined threshold.

The processor may extract or generate an ad-hoc voice print (or voice signature) of the individual who is speaking (i.e., individual 1620) from the audio segment obtained in step 2320 (step 2330). The term ad-hoc voice print may refer to a voice print generated based on a current first audio segment and used for processing second audio segments which may be received soon after (or from the same location as) the first audio segment. It will be appreciated, however, that the voice print may or may not be discarded, and may be stored and used in the future for processing other audio segments captured at a later time, in a different location, or the like. As would be recognized by a person skilled in the art, the voice print includes one or more measurable characteristics of the voice of individual 1620 that may uniquely identify individual 1620 as the individual sounds in the audio segment. The voice print may be obtained in any manner. In some embodiments, generating the voice print may include extracting one or more characteristics (e.g., pitch, tone, rate of speech, volume, rhythm, tempo, texture, resonance, center frequency, frequency distribution, responsiveness, etc.) of the speaker's voice from the audio segment. The voice print may be expressed in any manner (e.g., one or more vectors of values, a formula generated using the characteristics, etc.).

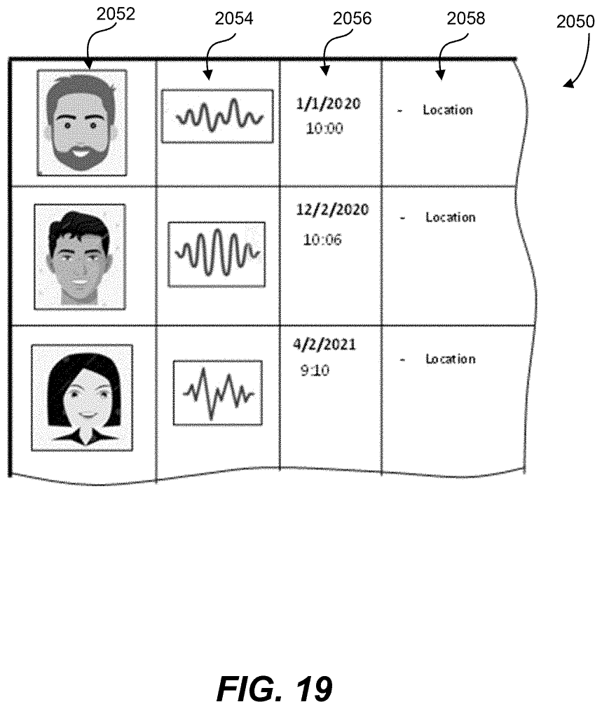

In some embodiments, the processor may store the ad-hoc voice print generated in step 2330 in a database 2050 (see FIGS. 13, 19) accessible to apparatus 100. As explained previously, database 2050 may store information (e.g., images, identifying information, etc.) about individuals that have previously interacted with user 100. In some embodiments, the processor may store the generated voice print in association with an image of the individual who is speaking (i.e., individual 1620) for future use. In some embodiments, the processor may also store an identifier of location 1600 (where the audio signals used to generate the voice print was captured) in database 2050 in association with the voice print. The location identifier may include any information that the processor can use to identify the location corresponding to a voice print. In some embodiments, the location identified may include one or more images that include a representation of location 1600. In some embodiments, the location identifier may be another indication (address, GPS location, etc.) that may be used to identify location 1600. In embodiments where a prior voice print associated with individual 1620 is already stored in database 2050, the processor may store the newly generated voice print along with or in addition to the prior voice print. In some embodiments, the processor may replace the prior voice print with the newly generated voice print (in step 2330). In some embodiments, the processor may compare the previously stored prior voice print with the newly generated voice print and replace the prior voice print stored in the database with the generated voice print when at least one characteristic or attribute (e.g., pitch, tone, rate of speech, volume, rhythm, tempo, texture, resonance, center frequency, frequency distribution, responsiveness, etc.) of the newly generated voice print is better in quality than at least one attribute (e.g., a corresponding attribute) of the prior voice print, or if the audio segment is known to be cleaner than audio segments used for generating previously stored voice prints. If the newly generated voice print is of lesser quality than a previously stored one, it may still be used ad-hoc for the current encounter, as it reflects the acoustic conditions at the time and location, but may not be used in other circumstances.

After generating the voice print in step 2330, the processor may receive additional audio signals (e.g., second audio signals) from the microphone. The additional audio signals may include sounds made by the same individual (i.e., individual 1620) whose voice print was generated in step 2330 (step 2340). The second audio signals received in step 2340 may include audio signals captured by the microphone within a predetermined time period after the first time period during which the first audio signals (received in step 2310) were captured by the microphone. Additionally, or alternatively, the second audio signals received in step 2340 may include audio signals captured by the microphone while the user 100 is in location 1600. Since the speaker voice characteristics (e.g., one or more of pitch, tone, rate of speech, volume, rhythm, tempo, texture, resonance, center frequency, frequency distribution, etc.) may change with the time of day and the speaker's health condition (if the speaker has a cold, etc.), capturing the second audio signals within a predetermined time after capturing the first audio signals may ensure that the speaker voice characteristics are similar in both the first and second audio signals. If both the first and second audio signals (received in steps 2310 and 2340, respectively) are captured from the same location (location 1600), the acoustic environment from which the first and second audio signals are captured may also be the same or similar.

That is, the audio signals received in step 2340 may include at least one of (a) sounds (e.g., speech, etc.) made by an individual within a predetermined time after the audio signals used to generate that same individual's voice print was captured, or (b) sounds made by an individual at the same location (i.e., location 1600) from which the audio signals used to generate that individual's voice print were captured. The predetermined time period may be any value of time (e.g., 1 hour, 45 minutes, 30 minutes, 20 minutes, 10 minutes, 5 minutes, 1 minute, 30 seconds, etc.) preselected by a user or otherwise predetermined. Since the second audio signals (with individual 1620's speech) received in step 2340 are captured at the same location (i.e., location 1600) and/or soon after (i.e., a predetermined time after) the first audio signals (used to generate individual 1620's voice print) are captured, both the first and second audio signals are captured under similar conditions. Therefore, the voice print generated in step 2330 will be a representation of individual 1620's voice under the same or similar conditions in which the second audio signals are recorded.

The processor may then process the second audio signals using the voice print generated in step 2350 (step 2330). In some embodiments, processing the second audio signals (in step 2330) may include amplifying the sounds of (e.g., speech of) individual 1620 in the second audio signals. Additionally, or alternatively, in some embodiments, processing the second audio signals may include attenuating sounds other than those of individual 1620 (e.g., sounds 1632 and 1642, see FIG. 16) in the second audio signals. Additionally, or alternatively, in some embodiments, processing the second audio signals may include adjusting one or more characteristics (e.g., pitch, tone, rate of speech, volume, rhythm, tempo, texture, resonance, center frequency, frequency distribution, responsiveness, etc.) of the sounds of individual 1620 in the second audio signals. Additionally, or alternatively, in some embodiments, processing the second audio signals may include transcribing the sounds (or speech) of individual 1620 in the second audio signals.

In some embodiments, processing the second audio signals (in step 2330) may include separating the speaker's voice (i.e., individual 1620) from additional speakers (e.g., individual 1630) or background noise (1642) in the received second audio signals. In some embodiments, an algorithm (e.g., a pre-trained neural network) may be used to process the second audio signals in step 2350 using the individual 1620's voice print and output the processed audio signals. Since the second audio signals are processed using the speaker's voice print generated under similar conditions (acoustic conditions, voice characteristic, etc.), the voice print is relevant and the quality of the processed audio signals may be good.

In some embodiments, the processor may transmit the processed second audio signals (from step 2350) to one or more electronic devices associated with user 100. These electronic devices may include a hearing interface device 1710, a bone conduction headphone 1711 (see FIG. 8), an earphone worn by the user, a headphone worn by the user, a portable electronic device (computing device 120), a storage device (memory 550), or another device. For example, the processor may process the second audio signals using the voice print to amplify the speakers voice, attenuate other's voice, change one or more characteristics of the speaker's voice (change frequency range, rate of speech, etc.), filter noise, etc., and then send the processed audio signals to hearing interface device 1710 or bone conduction headphone 1711 to enable the user to clearly hear the speaker. In some embodiments, the processed audio signals may be processed using an algorithm (e.g., a speech recognition algorithm) to create a digital transcript of the speaker's speech.

Thus, in process 2300 of FIG. 17, a voice print based on the speaker's speech captured under the same or similar conditions may be used to process audio signals and/or speech by the speaker, and improve the quality of the processed audio signals. The conditions may relate to the acoustic environment of the user (e.g., acoustics of the room or other location where the user is interacting with other individuals) and/or to the speaker's voice characteristics (e.g., one or more of pitch, tone, rate of speech, volume, rhythm, tempo, texture, resonance, center frequency, frequency distribution, etc.) that may change in accordance with the time of day, the speaker's condition (if the speaker has a cold, etc.), etc.

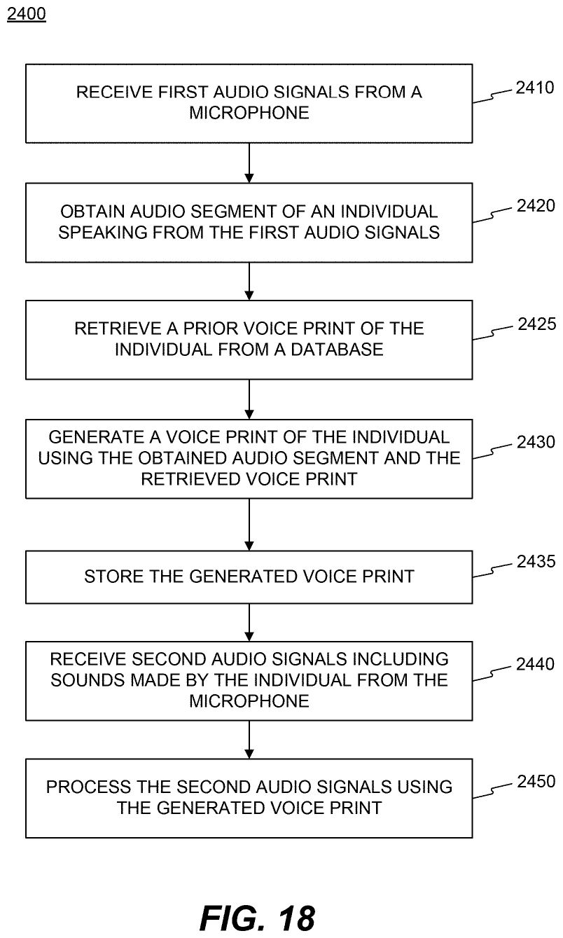

FIG. 18 is a flowchart showing another exemplary process 2300 for processing audio signals. Since process 2300 is similar to process 2200 (of FIG. 17), only the steps of process 2300 that are different from process 2200 will be described in detail. As described with reference to steps 2310 and 2320 of process 2300, the processor associated with apparatus 110 may receive first audio signals from the microphone of apparatus 110 in step 2410 and obtain an audio segment from the received audio signals in step 2420. The obtained audio segment (in step 2420) may include a portion of the audio signals where an individual (e.g., individual 1620) is speaking. As described with reference to step 2320, in some embodiments, the audio segment in step 2420 may be selected such that only a single individual (i.e., individual 1620) is speaking and this individual's speech is clear. A prior voice print of individual 1620 stored in the database 2050 may be retrieved (step 2425).

As explained previously, database 2050 may store information such as, for example, images, features extracted from images, voice prints, and other identifying information about individuals who have previously interacted with user 100. FIG. 19 is an illustration of an exemplary database 2050 accessible to apparatus 100. Database 2050 may be stored in any memory accessible to apparatus 110 (e.g., memory 550 of apparatus 110 (see FIG. 5A), memory 550b of computing device 120, memory or storage device of server 250 of FIG. 2, etc.). As illustrated in FIG. 19, database 2050 may include an image 2052 and associated voice print 2054 of multiple individuals who have interacted with user 100. A time stamp 2056 (e.g., the date and time) indicative of the time at which the audio signal (that resulted in the voice print) was captured, and a location indicator indicative of the location (e.g., location 1600 of FIG. 16) from which the audio signal was captured may also be stored in database 2050. It should be noted that although a single image 2052, voice print 2054, time stamp 2056, and location indicator 2058 are illustrated in FIG. 19, this is only exemplary. In some embodiments, multiple images 2052 and/or voice prints 2054 may be stored in database 2050. In some such embodiments, time stamps 2056 and location indicators 2058 corresponding to the different voice prints 2054 may also be stored. In some embodiments, other details may also be stored in database 2050. When the user 100 meets a speaker (any individual), if no data related to the speaker is stored in the database 2050, a new entry may be created and associated with the speaker.

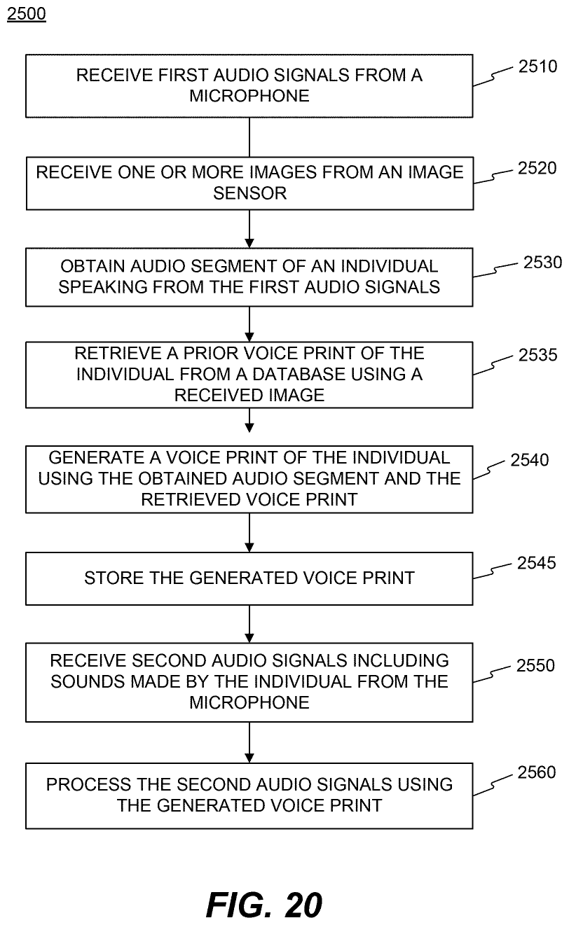

Referring again to FIG. 18, in step 2425, a prior voice print of individual 1620 (i.e., the speaker) stored in database 2050 may be retrieved by the processor. To identify individual 1620's prior voice print in the database 2050, the processor may compare one or characteristics (e.g., pitch, tone, rate of speech, volume, rhythm, tempo, texture, resonance, center frequency, frequency distribution, responsiveness, etc.) of individual 1620's voice in the audio segment obtained in step 2420 with those in the voice prints 2054 stored in database 2050. If one or more characteristics in the audio segment matches the corresponding characteristics of a stored voice print 2054, the processor may identify the speaker and retrieve the appropriate voice print. Thus, in some embodiments, apparatus 110 may be configured to identify the speaker based on the received audio signals in step 2410. As will be described below with reference to FIG. 20, in some embodiments, the speaker may be recognized based on a comparison of the speaker's image recorded during the interaction with the images 2052 stored in the database 2050.

A voice print of individual 1620 (the speaker) may then be generated using the audio segment obtained in step 2420 and the prior voice print of individual 1620 retrieved from database 2050 in step 2425. As explained in step 2330 of process 2300, the processor may generate individual 1620's voice print in any manner known in the art. For example, by extracting one or more characteristics (e.g., pitch, tone, rate of speech, volume, rhythm, tempo, texture, resonance, center frequency, frequency distribution, responsiveness, etc.) of the speaker's voice from the audio segment and the retrieved voice print.

The generated voice print may then be stored in database 2050 (step 2435). In some embodiments, the newly generated voice print (in step 2430) may be stored in association with the prior voice print 2054 of individual 1620 stored in the database 2050. In some embodiments, in step 2435, the newly generated voice print may replace the prior voice print 2054 in database 2050. In some embodiments, the prior voice print 2054 may be replaced with the newly generated voice print if and when at least one attribute of the newly generated voice print is better in quality than at least one attribute of the prior voice print 2054. In some embodiments, a grade or score may be associated with each stored prior voice print 2054 based, for example, on its quality. The grade may be generated, for example, based on one or more of a quality characteristic (clarity, pitch, frequency, noise level, etc.) of the audio signal from which the voice print was generated, the length of the audio, additional audio signal parameters, etc. In general, any known technique to grade audio signals may be used to grade voice print 2054. For example, in some embodiments, the International Telecommunications Union (ITU) standard for audio quality (BS1387), commonly referred to as perceptual evaluation of audio quality (PEAQ), may be used to grade the audio signals. If a newly generated voice print (in step 2430) is of higher quality that a prior voice print 2054 stored in database 2050, the prior voice print 2054 may be replaced with the newly generated voice print. In some embodiments, if at least one characteristic or attribute (or a selected number of attributes) of the newly generated voice print is better in quality than the prior voice print 2054, the prior voice print 2054 may be replaced with the newly generated voice print. In some embodiments, the newly generated voice print (in step 2430) may be used to enhance or enrich (e.g., increase the length, etc.) the prior voice print 2054 in database 2050.

In some embodiments, in step 2435, the newly generated voice print (in step 2430) may be stored in database 2050 in association with an identifier of the location (e.g., location identifier 2058) from which the audio signals used to generate the voice print was captured (i.e., location 1600 of FIG. 16). The location identifier may be any indicator that enables the location to be identified (e.g., GPS location, street address, room number or name, building number or name, city, town, etc.).

The processor may receive additional audio signals (second audio signals) from the microphone of apparatus (step 2440). The second audio signals received in step 2440 may include sounds made by the same individual (i.e., individual 1620) whose voice print was generated in step 2430. As described with reference to step 2340 of process 2300, the second audio signals received in step 2440 of process 2400 may include at least one of (a) sounds (e.g., speech, etc.) made by individual 1620 within a predetermined time after the audio signals used to generate individual 1620's voice print was captured, or (b) sounds made by individual 1620 at the same location (i.e., location 1600) from which the audio signals used to generate individual 1620's voice print was captured. As described previously, the predetermined time period may be any value of time (e.g., 1 hour, 45 minutes, 30 minutes, 20 minutes, 10 minutes, 5 minutes, 1 minute, 30 seconds, etc.) selected by a user or otherwise predetermined. Since the second audio signals received in step 2440 are captured at the same location (i.e., location 1600) and/or soon after (i.e., a predetermined time after) the first audio signals (received in step 2410) are captured, both the first and second audio signals may be captured under the same or similar conditions. Therefore, the voice print generated in step 2430 using individual 1620's voice in the first audio signals may be a true representation of that individual's voice in the second audio signals.

The processor may then process the second audio signals using the voice print generated in step 2430 (step 2450). The second audio signals may be processed in the same manner as described in step 2350 of process 2300. For example, the processor may process the second audio signals by amplifying the speaker's voice, attenuating other people's voice, changing one or more characteristics of the speaker's voice (pitch, tone, change rate of speech, etc.), filtering noise, etc. As in process 2300, in some embodiments, the processor may transmit the processed second audio signals (from step 2450) to one or more electronic devices (e.g., hearing interface device 1710, bone conduction headphone 1711, earphone, headphone, computing device 120, storage device, etc.) associated with user 100. Thus, as in process 2300 of FIG. 17, in process 2400 of FIG. 18, a speaker's speech is processed using an ad-hoc voice print generated using audio signals of the speaker's speech captured under the same or similar conditions.

FIG. 20 is a flowchart showing another exemplary process 2500 for processing audio signals received by the processor associated with apparatus 110. Since process 2500 is similar to process 2200 (of FIG. 17) and process 2300 (of FIG. 18), only the steps of process 2500 that are different from processes 2200, 2300 will be described in detail. As described with reference to step 2310 of process 2300 (and step 2410 of process 2400), the processor receives first audio signals from the microphone of apparatus 110 in step 2510. The processor may also receive one or more images from the image sensor of apparatus 110 (step 2520). The received images may include images with a representation of the individuals (e.g., individuals 1620, 1630 of FIG. 16) that user 100 is interacting with and images with a representation of location 1600 where user 100 is interacting with these individuals.

The processor may then obtain an audio segment of an individual speaking (e.g., individual 1620) from received first audio segment (step 2530). In this step, the processor may differentiate the portion of the first audio signals in which individual 1620 is speaking from other portions of the audio signal to obtain the audio segment. In step 2530, the processor may differentiate the portion of the first audio signals in which individual 1620 is speaking based on analysis of one or more of the images received in step 2520. For example, the processor may detect who is speaking at a time, based on facial features (e.g., lip movement, lip position, etc.) of the individuals captured in the received images. If one or more of the received images indicate (e.g., based on lip movement) that individual 1620 is speaking, the processor may obtain a portion of the audio signals received at that time as an audio segment in which individual 1620 is speaking. As described with reference to step 2320 of process 2300, in some embodiments, the audio segment may be obtained in step 2530 such that only individual 1620 is speaking in that time period and individual 1620's voice is clear (e.g., no background noise, etc.). As explained previously, the processor may detect that only individual 1620 is speaking based on an analysis of the received images. For example, the processor may analyze the facial features of all the individuals that the user is interacting with (e.g., individuals 1620, 1630) to determine that only individual 1620 is speaking.

A prior voice print of individual 1620 stored in the database 2050 may then be retrieved using a received image (step 2535). The processor may compare an image of the speaker (i.e., individual 1620) received in step 2520 with images 2052 stored in database 2050 to identify a prior voice print of individual 1620 stored in database 2050. If one or more characteristics of the received image of the speaker matches an image 2052 stored in database 2050, the processor may retrieve voice print 2054 stored in association with the matching image as the prior voice print. A voice print of individual 1620 (the speaker) may then be generated using the audio segment obtained in step 2530 and the prior voice print retrieved from database 2050 in step 2525 (step 2540). The voice print of individual 1620 may be generated in step 2540 in the same manner as it is generated in step 2430 of process 2400.

The newly generated voice print may then be stored in database 2050 (step 2545). As explained with reference to step 2435 of process 2400, in some embodiments, the newly generated voice print may be stored in association with prior voice print 2054 already stored in the database 2050. In some embodiments, the newly generated voice print may replace prior voice print 2054 stored in database 2050. In some embodiments, prior voice print 2054 may be replaced with the newly generated voice print if and when at least one attribute of the newly generated voice print is better in quality than at least one attribute of the prior voice print 2054.

The processor may receive additional audio signals (second audio signals) from the microphone of apparatus (step 2550). The second audio signals received in step 2550 may include sounds made by the same individual (i.e., individual 1620) whose voice print was generated in step 2540. As described with reference to step 2340 of process 2300 (and step 2440 of process 2400), the second audio signals received in step 2550 of process 2500 may include at least one of (a) sounds (e.g., speech, etc.) made by individual 1620 within a predetermined time after the audio signals used to generate individual 1620's voice print was captured, or (b) sounds made by individual 1620 at the same location (i.e., location 1600) from which the audio signals used to generate individual 1620's voice print was captured. Since the second audio signals received in step 2550 are captured at the same location (i.e., location 1600) and/or soon after (i.e., a predetermined time after) the first audio signals (received in step 2510) are captured, both the first and second audio signals are captured under the same or similar conditions. Therefore, the voice print generated in step 2540 using individual 1620's voice in the first audio signals is a true representation of that individual's voice in the second audio signals.

The processor may then process the second audio signals using the voice print generated in step 2540 (step 2560). The second audio signals may be processed in the same manner as described in step 2350 of process 2300 (and step 2450 of process 2400). For example, the processor may process the second audio signals by amplifying the speakers voice, attenuating other people's voice, changing one or more characteristics of the speaker's voice (pitch, tone, change rate of speech, etc.), filtering noise, etc. As in processes 2300 and 2400, in some embodiments, the processor may transmit the processed second audio signals (from step 2560) to one or more electronic devices (e.g., hearing interface device 1710, bone conduction headphone 1711, earphone, headphone, computing device 120, storage device, etc.) associated with user 100. Thus, as in processes 2300 of FIGS. 17 and 2400 of FIG. 18, in process 2500 of FIG. 20, a speaker's speech is processed using an ad-hoc voice print generated using audio signals of the speaker's speech captured under the same or similar conditions, thereby improving the quality of the processed audio signals.

It will be appreciated that the foregoing description may be implemented on any wearable device configured to capture audio (and images or video in some embodiments) of the surroundings of a person. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, Ultra HD Blu-ray, or other optical drive media.

Computer programs based on the written description and disclosed methods are within the skill of an experienced developer. The various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. A wearable device for processing audio signals, comprising:
a microphone configured to capture sounds from an environment of a user of the wearable device; and
at least one processor programmed to:
receive first audio signals, wherein the first audio signals are representative of sounds captured by the microphone during a first time period during which the user is in a location;
obtain an audio segment from the first audio signals, wherein the audio segment includes a portion of the first audio signals in which an individual is speaking;
generate a voice print of the individual using at least the audio segment;
receive second audio signals representative of additional sounds captured by the microphone, wherein the additional sounds include sounds made by the individual, and wherein the second audio signals are at least one of (a) audio signals captured by the microphone within a predetermined time period after the first time period, or (b) audio signals captured by the microphone while the user is in the location; and
process the second audio signals using the generated voice print.

2. The wearable device of claim 1, wherein the at least one processor is configured to obtain the audio segment by selecting a portion of the received first audio signals where no other individual other than the individual is speaking.

3. The wearable device of claim 1, wherein the at least one processor is further programmed to retrieve a prior voice print of the individual stored in a database.

4. The wearable device of claim 3, wherein the at least one processor is programmed to generate the voice print of the individual using the obtained audio segment and the retrieved prior voice print.

5. The wearable device of claim 3, wherein the at least one processor is further programmed to store the generated voice print in the database in association with the prior voice print.

6. The wearable device of claim 3, wherein the at least one processor is further programmed to replace the prior voice print stored in the database with the generated voice print when at least one attribute of the generated voice print is better in quality than at least one attribute of the prior voice print.

7. The wearable device of claim 1, wherein the at least one processor is further programmed to store the generated voice print in the database in association with an identifier of the location of the user.

8. The wearable device of claim 7, further comprising an image sensor configured to capture one or more images from the environment of the user, wherein the at least one processor is further programmed to receive an image including a representation of the location from the image sensor, and retrieve a prior voice print of the individual stored in the database based on the representation of the location in the received image, and wherein the at least one processor is programmed to generate the voice print of the individual using the obtained audio segment and the retrieved prior voice print.

9. The wearable device of claim 3, wherein the at least one processor is further programmed to recognize the individual based on the received first audio signals.

10. The wearable device of claim 1, wherein the predetermined time period is 10 minutes.

11. The wearable device of claim 1, wherein the at least one processor is programmed to process the second audio signals by at least one of (i) amplifying the sounds of the individual in the additional sounds, (ii) attenuating sounds other than those of the individual in the additional sounds, (iii) adjusting one or more characteristics of the sounds of the individual in the additional sounds, or (iv) transcribing the sounds of the individual in the additional sounds.

12. The wearable device of claim 1, wherein the at least one processor is further programmed to cause transmission of the processed second audio signals to an electronic device associated with the user.

13. The wearable device of claim 12, wherein the electronic device is at least one of a hearing aid worn by the user, an earphone worn by the user, a headphone worn by the user, a portable electronic device, or a storage device.

14. The wearable device of claim 1, further comprising an image sensor configured to capture one or more images from the environment of the user, wherein the at least one processor is further programmed to receive an image including a representation of the individual from the image sensor, and retrieve a prior voice print of the individual stored in a database using the image, and wherein the at least one processor is programmed to generate the voice print of the individual using the obtained audio segment and the retrieved prior voice print.

15. The wearable device of claim 14, wherein the at least one processor is further programmed to retrieve the prior voice print of the individual from the database by comparing the received image with a plurality of images stored in the database in association with voice prints.

16. A non-transitory computer-readable medium storing instructions that, when executed by at least one processor, cause the at least one processor to perform a method comprising:
receiving first audio signals from a microphone of a wearable device, wherein the first audio signals are representative of sounds captured by the microphone during a first time period during which a user of the wearable device is in a location;
obtaining an audio segment from the first audio signals, wherein the audio segment includes a portion of the first audio signals in which an individual is speaking;
generating a voice print of the individual using at least the audio segment;
receiving second audio signals representative of additional sounds captured by the microphone, wherein the additional sounds include sounds made by the individual, and wherein the second audio signals are at least one of (a) audio signals captured by the microphone within a predetermined time period after the first time period, or (b) audio signals captured by the microphone while the user is in the location; and
processing the second audio signals using the generated voice print.

17. The non-transitory computer-readable medium of claim 16, the method further including retrieving a prior voice print of the individual stored in a database, wherein generating the voice print of the individual includes generating the voice print using the obtained audio segment and the retrieved prior voice print.

18. The non-transitory computer-readable medium of claim 17, the method further including at least one of (a) storing the generated voice print in the database in association with the prior voice print or (b) replacing the prior voice print stored in the database with the generated voice print.

19. The non-transitory computer-readable medium of claim 16, wherein obtaining the audio segment includes selecting a portion of the received first audio signals where no other individual other than the individual is speaking.

20. A method of processing audio signals, comprising:
receiving first audio signals from a microphone of a wearable device, wherein the first audio signals are representative of sounds captured by the microphone during a first time period during which a user of the wearable device is in a location;
obtaining an audio segment from the first audio signals, wherein the audio segment includes a portion of the first audio signals in which an individual is speaking;
generating a voice print of the individual using at least the audio segment;
receiving second audio signals representative of additional sounds captured by the microphone, wherein the additional sounds include sounds made by the individual, and wherein the second audio signals are at least one of (a) audio signals captured by the microphone within a predetermined time period after the first time period, or (b) audio signals captured by the microphone while the user is in the location; and
processing the second audio signals using the generated voice print.
